(19) United States
(12) Patent Application Publication
(10) Pub. No.: US 2018/0091932 A1
(43) Pub. Date: Mar. 29, 2018

(54) METHOD AND DEVICE FOR CONTROLLING DEVICE USING BLUETOOTH LOW-POWER ENERGY TECHNOLOGY

(71) Applicant: LG ELECTRONICS INC., Seoul (KR)

(72) Inventor: Younghwan KWON, Seoul (KR)

(73) Assignee: LG ELECTRONICS INC., Seoul (KR)

(21) Appl. No.: 15/563,412

(22) PCT Filed: Mar. 31, 2016
(86) PCT No.: PCT/KR2016/003316

§ 371 Date: Sep. 29, 2017

Related U.S. Application Data
(60) Provisional application No. 62/141,798, filed on Apr. 1, 2015.

(51) Int. Cl. H04W 4/00; H04W 12/06; H04W 8/00

(52) U.S. Cl. CPC H04W 4/008; H04W 12/06; H04W 76/021; H04W 76/023; H04W 4/005; H04W 8/005

(57) ABSTRACT

The present invention relates to a method and a device for controlling, by a control device, pairing of a first device and a second device using a Bluetooth low energy (LE). According to the present invention, the control device receives supportable service information and pairing mode information from the first and second devices, sends, to the first and second devices, a message for instructing a specific operation, and sends a specific value or determines whether to perform direct pairing or not, thereby controlling the pairing of the first and second devices.

### TECHNICAL FIELD

The present invention relates to a method and device for forming a connection between devices using Bluetooth, short-range technology, in a wireless communication system, and more particularly, to a method and device for forming a connection between devices using a Bluetooth low energy (BLE) technology.

### BACKGROUND ART

Bluetooth is a short-range wireless technology standard that can wirelessly connect various types of devices and allows them to exchange data over short distances. To enable wireless communication between two devices using Bluetooth communication, a user has to perform the process of discovering Bluetooth devices to communicate with and making a connection request. As used herein, the term “device” refers to an appliance or equipment.

Here, the user may discover a Bluetooth device according to a Bluetooth communication method intended to be used using the Bluetooth device, and subsequently perform a connection.

The Bluetooth communication method may be classified as a BR/EDR method and an LE method. The BR/EDR method may be termed Bluetooth Classic. The Bluetooth Classic method includes a Bluetooth technology led from Bluetooth 1.0 and a Bluetooth technology using an enhanced data rate (EDR) supported by Bluetooth 2.0 or a subsequent version.

A Bluetooth low energy (LE) technology applied, starting from Bluetooth 4.0, may stably provide information of hundreds of kilobytes (KB) at low power consumption. Such a Bluetooth low energy technology allows devices to exchange information with each other by utilizing an attribute protocol. The Bluetooth LE method may reduce energy consumption by reducing overhead of a header and simplifying an operation.

Among the Bluetooth devices, some products do not have a display or a user interface. Complexity of connection, management, control, and disconnection among various types of Bluetooth devices and Bluetooth device employing similar technologies has increased.

Bluetooth supports a high speed at relatively low power consumption and at relatively low cost. However, since a transmission distance thereof is 100 m at the maximum, and thus, Bluetooth is appropriately used within a limited space.

### DISCLOSURE

### Technical Problem

An aspect of the present invention provides a method for controlling a device using a Bluetooth low energy (BLE) technology (or BLE technique).

Another aspect of the present invention provides a method for controlling a connection of a device using a BLE technology.

Another aspect of the present invention provides a method for obtaining state information of a device using a BLE technology.

Another aspect of the present invention provides a method for defining a generic attribute profile (GATT) structure for controlling a connection between devices using a BLE technology.

Another aspect of the present invention provides a method for setting and releasing a password for controlling a connection between devices using a BLE technology.

Another aspect of the present invention provides a method for setting a device for controlling a connection between devices using a BLE technology.

Another aspect of the present invention provides a method for allowing a control device to set a pairing method of a device using a BLE technology, thereby preventing the device from being controlled by an external device.

Another aspect of the present invention provides a method for allowing a control device to set an authentication method of a device using a BLE technology, thereby preventing the device from being controlled by an external device.

Another aspect of the present invention provides a method for allowing a control device to set a discoverable mode of a device or an operation time of a discoverable mode using a BLE technology, thereby preventing the device from being controlled by an external device.

Technical subjects obtainable from the present invention are non-limited by the above-mentioned technical task. And, other unmentioned technical tasks can be clearly understood from the following description by those having ordinary skill in the technical field to which the present invention pertains.

### Technical Solution

The present disclosure provides a method for controlling, by a first device, a second device using a BLE technology.

In detail, a method for controlling, by a first device, a second device using a Bluetooth low energy (BLE) technology includes: receiving a first advertising message including at least one of first service information or first pairing mode information supported by the first device from the first device; establishing a BLE connection with the first device; transmitting a first control message including a first operation code indicating an advertising operation to the first device; receiving a second advertising message including at least one of second service information or second pairing mode information supported by the second device from the second device; establishing a BLE connection with the second device; transmitting a second control message including a second operation code indicating a connection operation and an ID representing the first device to the second device; and receiving a notification message including state information indicating a pairing result from at least one of the first device or the second device.

Also, in the present disclosure, each of the first pairing mode information and the second pairing mode information may include at least one of OOB (Out-Of-Band), Passkey Entry, Numeric Comparison, or Just works.

Also, in the present disclosure, the method may further include: transmitting a first write request message for setting a pairing mode of the first device to a first specific pairing mode, to the first device; and transmitting a second write request message for setting a pairing mode of the second device to a second specific pairing mode, to the second device, wherein the first specific pairing mode and the second specific pairing mode may be one of OOB (Out-Of-Band), Passkey Entry, Numeric Comparison, and Just works.

Also, in the present disclosure, the method may further include: receiving a first value for device authentication from the first device; receiving a second value for device authentication from the second device; and comparing the first value and the second value.

Also, in the present disclosure, the method may further include: transmitting a write request message requesting writing of whether pairing is permitted to at least one of the first device and the second device according to a comparison result.

Also, in the present disclosure, when the first value is the same as the second value, the write request message may request writing of permission of pairing.

Also, in the present disclosure, when the first value and the second value are different, the write request message may request writing of non-permission of pairing.

Also, in the present disclosure, the method may further include: transmitting a first write request message requesting writing of a first passkey value for device authentication to the second device; receiving a second passkey value for device authentication from the first device; and comparing the first passkey value and the second passkey value.

Also, in the present disclosure, the method may further include: transmitting a second write request message requesting writing of whether pairing is permitted, to the first device according to a comparison result.

Also, in the present disclosure, the method may further include: transmitting a first write request message requesting writing of a first passkey value for device authentication to the first device; and transmitting a second write request message requesting writing of a second passkey value for device authentication to the second device.

Also, the present disclosure provides a method including: transmitting a first advertising message including at least one of first service information or first pairing mode information supported by a first device, to a control device; establishing a Bluetooth low energy (BLE) connection with the control device; receiving a first control message including a first operation code indicating an advertising operation from the control device; transmitting a second advertising message to a second device according to the first operation code; receiving a connection request message requesting formation of a BLE connection from the second device; performing a device authentication procedure with the second device; and transmitting a notification message including state information indicating a pairing result to the control device.

Also, the present disclosure may further include: receiving a first write request message for setting a pairing mode of the first device to a specific pairing mode, from the first device; and performing the authentication procedure with the second device through the specific pairing mode, wherein the specific pairing mode and the second specific pairing mode may be one of OOB (Out-Of-Band), Passkey Entry, Numeric Comparison, and Just works.

Also, in the present disclosure, the method may further include: receiving a write request message requesting writing of an operation time of an advertising operation for transmitting the second advertising message, from the control device; and transmitting a write response message as a response with respect to the write request message, wherein the second advertising message may be transmitted only for the operation time.

Also, in the present disclosure, the method may further include: receiving a first write request message requesting writing of a first passkey value for device authentication from the control device; and setting a passkey for the authentication procedure to the first passkey value.

Also, in the present disclosure, the performing of the authentication procedure may comprise: receiving a second passkey value for authentication of the second device; and comparing the first passkey value and the second passkey value.

Also, in the present disclosure, when the first passkey value and the second passkey value are the same, the state information may indicate successful pairing.

Also, in the present disclosure, when the first passkey value and the second passkey value are different, the state information may indicate pairing failure.

Also, the present disclosure provides a device as a first device for controlling a second device using Bluetooth low energy (BLE), includes: a communication unit communicating with the exterior wirelessly or wiredly; and a processor functionally connected to the communication unit, wherein the processor performs control to receive a first advertising message including at least one of first service information or first pairing mode information supported by the first device from the first device, establish a BLE connection with the first device, transmit a first control message including a first operation code indicating an advertising operation to the first device, receive a second advertising message including at least one of second service information or second pairing mode information supported by the second device from the second device, establish a BLE connection with the second device, transmit a second control message including a second operation code indicating a connection operation and an ID representing the first device to the second device, and receive a notification message including state information indicating a pairing result from at least one of the first device or the second device.

### Advantageous Effects

According to the method for controlling a device using a BLE technology in an embodiment of the present disclosure, a connection between other devices may be controlled through the control device.

Also, according to the present disclosure, a connection of another device may be controlled by obtaining information of a network interface supported by the other device through the control device using the BLE technology.

Also, according to the present disclosure, a connection of another device may be controlled by obtaining information of a network interface supported by the other device through the control device using the BLE technology, whereby the connection between other devices may be effectively performed.

Also, according to the present disclosure, by controlling a connection between other devices through the control device using the BLE technology, a connection of a device without a user interface (UI) may be effectively performed.

Also, according to the present disclosure, a BLE connection providing low power consumption and stable connectivity may be formed using the BLE technology.

Also, according to the present disclosure, a password for controlling a connection between devices may be set and released using the BLE technology.

Also, according to the present disclosure, a device for controlling a connection between devices may be set using the BLE technology.

Also, according to the present disclosure, by setting a pairing method of a device by the control device using the BLE technology, a connection of an external device to a device for controlling the device may be prevented.

Also, according to the present disclosure, by setting an authentication method of a device by the control device using the BLE technology, a device may be connected only through the set authentication method.

Also, according to the present disclosure, by setting a discoverable mode of a device or a time of the discoverable mode by the control device using the BLE technology, a device may be prevented from being controlled by an external device.

Advantages and effects of the present invention that may be obtained in the present invention are not limited to the foregoing effects and any other technical effects not mentioned herein may be easily understood by a person skilled in the art from the present disclosure and accompanying drawings.

### DESCRIPTION OF DRAWINGS

FIG. 1 is a schematic view illustrating an example of a wireless communication system using Bluetooth low energy (BLE) technology proposed in this disclosure.

FIG. 2 illustrates an internal block diagram of an example of a device implementing methods proposed in this disclosure.

FIG. 3 illustrates an example of BLE topology.

FIG. 4 is a view illustrating an example of Bluetooth communication architecture to which methods proposed in this disclosure may be applied.

FIG. 5 is a view illustrating an example of a structure of a generic attribute profile (GATT) of BLE.

FIG. 6 is a flow chart illustrating a method of forming a connection using BLE between devices.

FIG. 7 is a flow chart illustrating a method for performing pairing by a device using BLE.

FIG. 8 is a view schematically illustrating a method for controlling formation of a connection between other devices through a control device according to an embodiment of the present disclosure.

FIG. 9 is a view illustrating an example of characteristics of GATT for controlling a device through a BLE technology according to an embodiment of the present disclosure.

FIGS. 10 to 15 are views illustrating an example of each characteristic according to an embodiment of the present disclosure.

FIG. 16 illustrates an example of a method for controlling a connection of other devices through a control device according to an embodiment of the present disclosure.

FIG. 17 illustrates another example of a method for controlling a connection of other devices through a control device according to an embodiment of the present disclosure.

FIG. 18 illustrates another example of a method for controlling a connection of other devices through a control device according to an embodiment of the present disclosure.

FIG. 19 illustrates another example of a method for controlling a connection of other devices through a control device according to an embodiment of the present disclosure.

FIG. 20 illustrates another example of a method for controlling a connection of other devices through a control device according to an embodiment of the present disclosure.

FIG. 21 illustrates another example of a method for controlling a connection of other devices through a control device according to an embodiment of the present disclosure.

FIG. 22 illustrates another example of a method for controlling a connection of other devices through a control device according to an embodiment of the present disclosure.

FIG. 23 illustrates another example of a method for controlling a connection of other devices through a control device according to an embodiment of the present disclosure.

FIG. 24 illustrates another example of a method for controlling a connection of other devices through a control device according to an embodiment of the present disclosure.

FIG. 25 is a view illustrating another example of characteristics of GATT for controlling a device through a BLE technology according to an embodiment of the present disclosure.

FIG. 26 is a view illustrating an example of characteristic information representing characteristics provided by a device according to an embodiment of the present disclosure.

FIG. 27 is a view illustrating an example of a method for setting a control device according to an embodiment of the present disclosure.

FIG. 28 is a view illustrating an example of a method for transmitting and receiving state information of a device according to an embodiment of the present disclosure.

FIG. 29 is a view illustrating an example of a method for setting a password for controlling a device according to an embodiment of the present disclosure.

FIGS. 30 and 31 are views illustrating another example of a method for setting a password for controlling a device and characteristics according to an embodiment of the present disclosure.

FIG. 32 is a view illustrating an example of a method for changing a password according to an embodiment of the present disclosure.

FIG. 33 is a schematic view illustrating an example of a method for preventing control by an external device according to an embodiment of the present disclosure.

FIG. 34 is a view illustrating an example of characteristics of a GATT for preventing control by an external device according to an embodiment of the present disclosure.

FIG. 35 is a view illustrating an example of each characteristic according to an embodiment of the present disclosure.

FIG. 36 is a view illustrating an example of characteristic information representing characteristics provided by a device according to an embodiment of the present disclosure.

FIG. 37 is a flow chart illustrating an example of a method for controlling an advertising operation of a device according to an embodiment of the present disclosure.

FIG. 38 is a flow chart illustrating another example of a method for controlling an advertising operation of a device according to an embodiment of the present disclosure.

FIGS. 39A and 39B are views illustrating an example of a method for performing a procedure for pairing devices by a control device according to an embodiment of the present disclosure.

FIGS. 40A and 40B are views illustrating another example of a method for performing a procedure for pairing devices by a control device according to an embodiment of the present disclosure.

FIGS. 41A and 41B are views illustrating another example of a method for performing a procedure for pairing devices by a control device according to an embodiment of the present disclosure.

### MODE FOR INVENTION

The aforementioned objects, features and advantages of the present invention will become more apparent through the following detailed description with respect to the accompanying drawings. Hereinafter, the embodiments of the present invention will be described with reference to the accompanying drawings, in which like numbers refer to like elements throughout the specification. In describing the present invention, a detailed description of known techniques associated with the present invention unnecessarily obscure the gist of the present invention, it is determined that the detailed description thereof will be omitted.

Hereinafter, a terminal related to the present invention will be described in detail with reference to the accompanying drawings. In the following description, usage of suffixes such as ‘module’, ‘part’ or ‘unit’ used for referring to elements is given merely to facilitate explanation of the present invention, without having any significant meaning by itself.

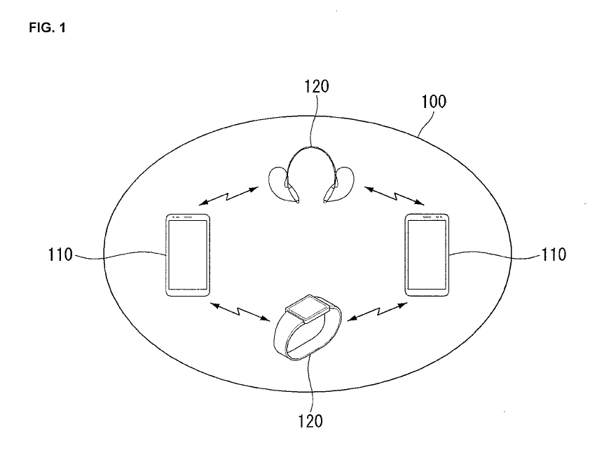

FIG. 1 is a schematic view illustrating an example of a wireless communication system using Bluetooth low energy (BLE) technology proposed in this disclosure.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may be expressed as a data service device, a slave device, a device, a slave, a server, a conductor, a host device, a gateway, a sensing device, a monitoring device, a first device, a second device, and the like.

The client device 110 may be expressed as a master device, a master, a client, a member, a sensor device, a sink device, a collector, a third device, a fourth device, and the like.

The server device and the client device correspond to major components of the wireless communication system, and the wireless communication system may include components other than the server device and the client device.

The server device refers to a device which receives data from the client device and provides data to the client device in response when a corresponding request is received from the client device, through direct communication with the client device.

Also, in order to provide data information to the client device, the server device sends a notification message or an indication message to the client device in order to provide data information to the client device. Also, the server device receives a confirmation message corresponding to the indication message from the client device.

Also, in the process of transmitting and receiving notification, indication, and confirmation messages to and from the client device, the server device may provide data information to a user through a display unit or may receive a request input from the user through a user input interface.

Also, in the process of transmitting and receiving message to and from the client device, the server device may read data from a memory unit or may write new data to the corresponding memory unit.

Also, the single server device may be connected with a plurality of client devices, and may be easily re-connected with client devices using bonding information.

The client device 120 refers to a device which requests data information and data transmission from the server device.

The client device receives data through a notification message or an indication message from the server device, and when an indication message is received from the server device, the client device sends an acknowledgement message in response to the indication message.

Similarly, in the process of transmitting and receiving messages to and from the server device, the client device may also provide information to the user through a display unit or may receive an input from the user through a user input interface.

Also, in the process of transmitting and receiving messages with the server device, the client device may read data from a memory unit or may write new data to the corresponding memory unit.

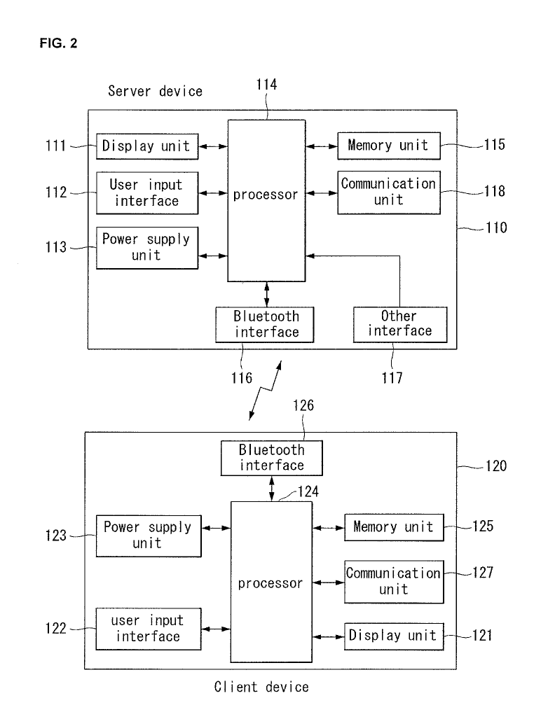

Hardware components such as the display units, the user input interfaces, and the memory units of the server device and the client device will be described in detail with reference to FIG. 2.

Also, the wireless communication system may configure personal area networking (PAN) through the Bluetooth technology. For example, in the wireless communication system, a private piconet may be established between devices to quickly and safely exchange files, documents, and the like.

FIG. 2 illustrates an internal block diagram of an example of a device implementing methods proposed in this disclosure.

As illustrated in FIG. 2, a server device includes a display unit 111, a user input interface 112, a power supply unit 113, a processor 114, a memory unit 115, a Bluetooth interface 116, other interface 117, and a communication unit (or transceiver unit) 118.

The display unit 111, the user input interface 112, the power supply unit 113, the processor 114, the memory unit 115, the Bluetooth interface 116, other interface 117, and the communication unit 118 are functionally connected to each other to perform a method proposed in this disclosure.

Also, the client device includes a display unit 121, a user input interface 122, a power supply unit 123, a processor 124, a memory unit 125, a Bluetooth interface 126, and a communication unit (or transceiver unit) 128.

The display unit 121, the user input interface 122, the power supply unit 123, the processor 124, the memory unit 125, the Bluetooth interface 126, other interface 127, and the communication unit 128 are functionally connected to each other to perform a method proposed in this disclosure.

The Bluetooth interfaces 116 and 126 refer to units (or modules) able to transmit data such as a request/a response, a command, a notification, an indication/confirmation message between devices.

The memory units 115 and 126 are units implemented in various types of devices, in which various types of data are stored.

The processors 114 and 124 refer to modules controlling a general operation of the server device or the client device, which control requesting transmission of a message through the Bluetooth interface and other interface and processing a received message therethrough.

The processors 114 and 124 may also be termed a controller, a control unit, and the like.

The processors 114 and 124 may include an application-specific integrated circuit (ASIC), other chip set, a logic circuit and/or data processing unit.

The processors 114 and 124 control the communication units to receive an advertising message from the server device, control the communication unit to transmit a scan request message to the server device and receive a scan response message as a response to the scan request from the server device, and control the communication unit to transmit a connection request message to the server device in order to establish a Bluetooth connection with the server device.

Also, after the Bluetooth LE connection is established through the connection procedure, the processors 114 and 124 control the communication units to read or write data by using an attribute protocol from the server device

The memory units 115 and 125 may include a read-only memory (ROM), a random access memory (RAM), a flash memory, a memory card, a storage medium and/or other storage device.

The communication units 118 and 127 may include a baseband circuit for processing a wireless signal. When an embodiment is implemented by software, the aforementioned technique may be implemented as a module (process, function, etc.) performing the aforementioned function. The module may be stored in a memory unit and may be executed by a processor.

The memory units 115 may be present within or outside of the processors 114 and 124, and may be connected to the processors 114 and 124 through various well-known units.

The display units 111 and 121 refer to modules providing status information of the devices, message exchange information, and the like, to the user through a screen.

The power supply units 113 and 123 refer to modules receiving external power or internal power and supplying power required for operations of the respective components under the control of the controllers 114 and 124.

As discussed above, the BLE technology has a small duty cycle and significantly reduce power consumption through a low data transfer rate.

The user input interfaces 112 and 122 refer to modules providing a user input such as a screen button to the controllers to enable the user to control an operation of the devices.

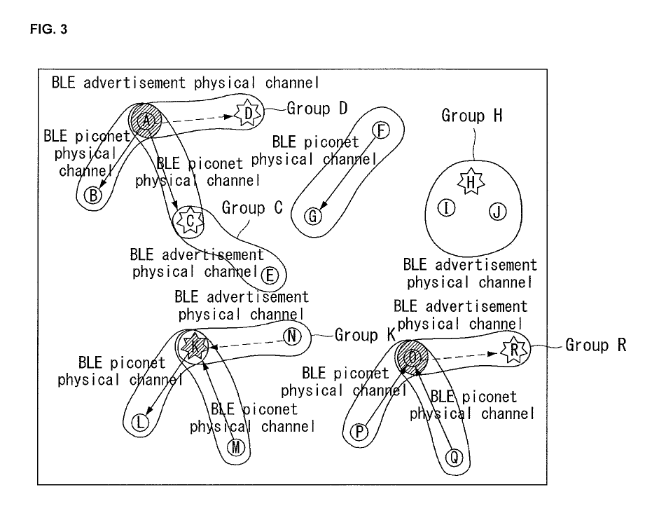

FIG. 3 illustrates an example of BLE topology.

Referring to FIG. 3, a device A corresponds to a master in a piconet (piconet A, the shaded portion) having a device B and a device C as slaves.

Here, the piconet refers to an aggregation of devices in which any one of them is a mater and the other devices occupy a shared physical channel connected to the master device.

The BLE slave does not share a common physical channel with the master. Each of the slaves communicates with the master trough a separate physical channel. There is another piconet (piconet F) having a master device F and a slave device G.

A device K is present in a scatternet K. Here, the scatternet refers to a group of piconets connected to other piconets.

The device K is a master of a device L and a slave of a device M.

A device O is also in the scatter net O. The device O is a slave of a device P and a slave of a device Q.

As illustrated in FIG. 2, five different device groups are present.

Device D is an advertiser and device A is an initiator (group D).

Device E is a scanner and Device C is an advertiser (group C).

Device H is an advertiser, and devices I and J are scanners (group H).

Device K is also an advertiser, and device N is an initiator (group K).

Device R is an advertiser, and device O is an initiator (group R).

The devices A and B use a single BLE piconet physical channel.

The devices A and C use another BLE piconet physical channel.

In group D, the device D advertises using an advertisement event connectable in an advertisement physical channel, and the device A is an initiator. The device A may establish a connection with the device D and add a device to the piconet A.

In group C, the device C advertises on an advertisement physical channel by using a certain type of an advertisement event captured by the scanner device E.

The group D and the group C may use different advertisement physical channels or different times in order to avoid collision.

In the piconet F, a single physical channel is present. The devices F and G use a single BLE piconet physical channel. The device F is a master, and the device G is a slave.

In group H, a single physical channel is present. The devices H, I, and J use a single BLE advertisement physical channel. The device H is an advertiser, and the devices I and J are scanners.

In the scatternet K, the devices K and L use a single BLE piconet physical channel. The devices K and M use another BLE piconet physical channel.

In group K, the device K advertises by using an advertisement event connectable on an advertisement physical channel, and the device N is an initiator. The device N may establish a connection with the device K. Here, the device K may be a slave of two devices and a master of one device at the same time.

In the scatternet O, the devices O and P use a single BLE piconet physical channel. The devices O and Q use another BLE piconet physical channel.

In group R, the device R advertises by using an advertisement event connectable on an advertisement physical channel, and the device O is an initiator. The device O may establish a connection with the device R. Here, the device O may be a slave of two devices and a master of one device at the same time.

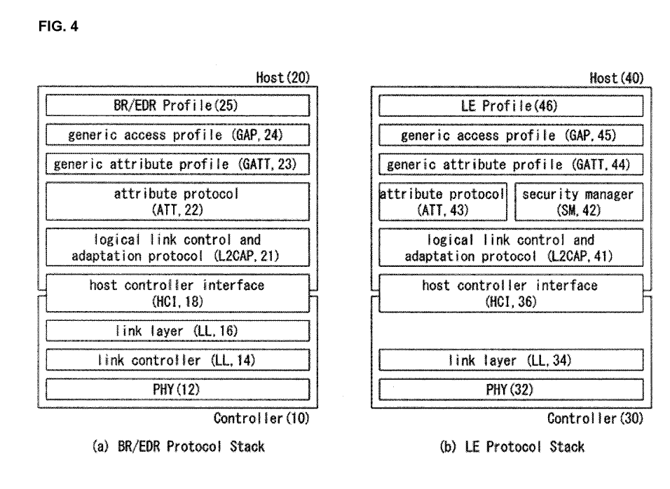

FIG. 4 is a view illustrating an example of a Bluetooth communication architecture to which the methods proposed in the present disclosure is implementable.

Referring to FIG. 4, FIG. 4 (a) shows an example of a protocol stack of the Bluetooth BR (Basic Rate)/EDR (Enhanced Data Rate), and FIG. 4 (b) shows an example of a protocol stack of the Bluetooth Low Energy (LE).

In detail, as illustrated in (a) of FIG. 4, the Bluetooth BR/EDR protocol stack may include an upper controller stack 10 and a lower host stack 20 with respect to a host controller interface (HCI) 18.

The host stack 20 refers to hardware for transmitting or receiving a Bluetooth packet to and from a wireless transceiver module receiving a Bluetooth signal of 2.4 GHz, and is connected to a Bluetooth module, the controller stack 10, to control the Bluetooth module and performs an operation.

The host stack 10 may include a PHY layer 12, a Link Controller layer 14 and a Link Manager layer 16.

The PHY layer 12 is the layer of transmitting and receiving a radio signals of 2.4 GHz, and may transmit data by hopping 79 RF channels in the case of using the Gaussian Frequency Shift Keying (GFSK) modulation.

The Link Controller layer 14 plays the role of transmitting a Digital Signal, selects the channel sequence of hopping 1400 times per second, and transmits the time slot of 625 μs length for each channel.

The Link Manager layer 16 controls the entire operations (link setup, control and security) of a Bluetooth connection by utilizing the Link Manager Protocol (LMP).

The link manager layer 16 may perform the following functions.

The link manager layer 16 may perform ACL/SCO logical transport, logical link setup, and control

Detach: The link manager layer 16 stops connection and informs a counterpart device about the reason for stopping connection.

The link manager layer 16 performs power control and role switch.

The link manager layer 16 performs security (authentication, pairing, encryption) function.

The host controller interface layer 18 provides an interface between the host module and the controller module to allow the host to provide a command and data to the controller and allow the controller to provide an event and data to the host.

The host stack (or host module) 20 includes a logical link control and adaptive protocol (L2CAP) 21, an attribute protocol (ATT) 22, a generic attribute profile (GATT) 23, a generic access profile (GAP) 24, and a BR/EDR profile 25.

The logical link control and adaptive protocol (L2CAP) 21 may provide a two-way channels for transmitting data to a specific protocol or a profile.

The L2CAP 21 may multiplex various protocols and profiles provided from a Bluetooth higher position.

The L2CAP of the Bluetooth BR/EDR uses a dynamic channel, supports a protocol service multiplexer, retransmission, and a streaming mode, and provides segmentation and reassembly, per-channel flow control, and error control.

The generic attribute profile (GATT) 23 may operate as a protocol how the attribute protocol 22 is used in configuring services. For example, the generic attribute profile 23 may operate how ATT attributes are grouped together with services, and operate to describe features associated with services.

Thus, the GATT 23 and the ATT 22 may use features in order to describe status and services of a device and describe how the features are related and used.

The attribute protocol 22 and the BR/EDR profile 25 define a service (profile) using the Bluetooth BR/EDR and define an application protocol for exchanging data, and the generic access profile (GAP) 24 defines device discovering, connecting a device and security level.

As illustrated in (b) of FIG. 4, the Bluetooth LE protocol stack includes a controller stack 30 operable to process a wireless device interface for which timing is important, and a host stack 40 operable to process high level data.

First, the controller stack 30 may be implemented by using a communication module that may include a Bluetooth wireless device, for example, a processor module that may include a processing device such as a microprocessor.

The host stack may be implemented as part of an OS operated on a processor module or may be implemented as instantiation of a package on the OS.

In some examples, the controller stack and the host stack may be operated or executed on the same processing device within a processor module.

The controller stack 30 includes a physical layer (PHY) 32, a link layer (LL) 34, and a host controller interface (HCI) 36.

The physical layer (PHY) (wireless transceiver module 32), a layer for transmitting and receiving a 2.4 GHz wireless signal, uses a Gaussian frequency shift keying (GFSK) modulation and a frequency hopping technique including forty RF channels.

The link layer 34 serving to transmit or receive a Bluetooth packet provides a function of generating a connection between devices after performing an advertising and scanning function using three advertising channels, and exchanging data packets of a maximum of 257 bytes through thirty-seven data channels.

The host stack may include the logical link control and the adaptation protocol (L2CAP) 41, the Security Manager (SM) 42, the Attribute Protocol (ATT) 43, the Generic Attribute Profile (GATT) 44, the Generic Access Profile 45 and the LE profile 46. However, the host stack 40 is not limited thereto, but may include other various protocols and profiles.

The host stack multiplexes various protocols and profiles provided from a Bluetooth higher position by using the L2CAP.

First, the L2CAP 41 may provide a single two-way channel for transmitting data to a specific protocol or profile.

The L2CAP 41 may operate to multiplex data between higher layer protocols, segment and reassemble packages, and manage a multicast data transmission.

In the Bluetooth LE, three fixed channels (one for a signaling channel, one for a security manager, and one for an attribute protocol) are basically used, and dynamic channel may be used as necessary.

In contrast, in the BR/EDR, a dynamic channel is basically used, and a protocol service multiplexer, retransmission, streaming mode, and the like, are supported.

The SM 42 is a protocol for certifying a device and providing a key distribution.

The ATT 43 defines a rule for accessing data of a counterpart device by a server-client structure. The ATT 43 includes six types of messages (request, response, command, notification, indication, and confirmation) as follows.

\textcircled{1} Request and Response message: A request message is a message for a client device to request specific information from a server device, and the response message, as a response message with respect to the request message, refers to a message transmitted from the server device to the client device.

\textcircled{2} Command message: It is a message transmitted from the client device to the server device in order to indicate a command of a specific operation. The server device does not transmit a response with respect to the command message to the client device.

\textcircled{3} Notification message: It is a message transmitted from the server device to the client device in order to notify an event, or the like. The client device does not transmit a confirmation message with respect to the notification message to the server device.

\textcircled{4} Indication and confirmation message: It is a message transmitted from the server device to the client device in order to notify an event, or the like. Unlike the notification message, the client device transmits a confirmation message regarding the indication message to the server device.

In the present invention, when the GATT profile using the attribute protocol (ATT) 43 requests long data, a value regarding a data length is transmitted to allow a client to clearly know the data length, and a characteristic value may be received from a server by using a universal unique identifier (UUID).

The generic access profile (GAP) 45, a layer newly implemented for the Bluetooth LE technology, is used to select a role for communication between Bluetooth LED devices and to control how a multi-profile operation takes place.

Also, the generic access profile (GAP) 45 is mainly used for device discovery, connection generation, and security procedure part, defines a scheme for providing information to a user, and defines types of attributes as follows.

\textcircled{1} Service: It defines a basic operation of a device by a combination of behaviors related to data

\textcircled{2} Include: It defines a relationship between services

\textcircled{3} Characteristics: It is a data value used in a server

\textcircled{4} Behavior: It is a format that may be read by a computer defined by a UUID (value type).

The LE profile 46, including profiles dependent upon the GATT, is mainly applied to a Bluetooth LE device. The LE profile 46 may include, for example, Battery, Time, FindMe, Proximity, Time, Object Delivery Service, and the like, and details of the GATT-based profiles are as follows.

\textcircled{1} Battery: Battery information exchanging method

\textcircled{2} Time: Time information exchanging method

\textcircled{3} FindMe: Provision of alarm service according to distance

\textcircled{4} Proximity: Battery information exchanging method

\textcircled{5} Time: Time information exchanging method

The generic attribute profile (GATT) 44 may operate as a protocol describing how the attribute protocol (ATT) 43 is used when services are configured. For example, the GATT 44 may operate to define how ATT attributes are grouped together with services and operate to describe features associated with services.

Thus, the GATT 44 and the ATT 43 may use features in order to describe status and services of a device and describe how the features are related and used.

Hereinafter, procedures of the Bluetooth low energy (BLE) technology will be briefly described.

The BLE procedure may be classified as a device filtering procedure, an advertising procedure, a scanning procedure, a discovering procedure, and a connecting procedure.

Device Filtering Procedure

The device filtering procedure is a method for reducing the number of devices performing a response with respect to a request, indication, notification, and the like, in the controller stack.

When requests are received from all the devices, it is not necessary to respond thereto, and thus, the controller stack may perform control to reduce the number of transmitted requests to reduce power consumption.

An advertising device or scanning device may perform the device filtering procedure to limit devices for receiving an advertising packet, a scan request or a connection request.

Here, the advertising device refers to a device transmitting an advertisement event, that is, a device performing an advertisement and is also termed an advertiser.

The scanning device refers to a device performing scanning, that is, a device transmitting a scan request.

In the BLE, in a case in which the scanning device receives some advertising packets from the advertising device, the scanning device should transmit a scan request to the advertising device.

However, in a case in which a device filtering procedure is used so a scan request transmission is not required, the scanning device may disregard the advertising packets transmitted from the advertising device.

Even in a connection request process, the device filtering procedure may be used. In a case in which device filtering is used in the connection request process, it is not necessary to transmit a response with respect to the connection request by disregarding the connection request.

Advertising Procedure

The advertising device performs an advertizing procedure to perform undirected broadcast to devices within a region.

Here, the undirected broadcast is advertizing toward all the devices, rather than broadcast toward a specific device, and all the devices may scan advertising to make an additional information request or a connection request.

In contrast, directed advertising may make an additional information request or a connection request by scanning advertising for only a device designated as a reception device.

The advertising procedure is used to establish a Bluetooth connection with an initiating device nearby.

Or, the advertising procedure may be used to provide periodical broadcast of user data to scanning devices performing listening in an advertising channel.

In the advertising procedure, all the advertisements (or advertisement events) are broadcast through an advertisement physical channel.

The advertising devices may receive scan requests from listening devices performing listening to obtain additional user data from advertising devices. The advertising devices transmit responses with respect to the scan requests to the devices which have transmitted the scan requests, through the same advertising physical channels as the advertising physical channels in which the scan requests have been received.

Broadcast user data sent as part of advertising packets are dynamic data, while the scan response data is generally static data.

The advertisement device may receive a connection request from an initiating device on an advertising (broadcast) physical channel. If the advertising device has used a connectable advertising event and the initiating device has not been filtered according to the device filtering procedure, the advertising device may stop advertising and enter a connected mode. The advertising device may start advertising after the connected mode.

Scanning Procedure

A device performing scanning, that is, a scanning device performs a scanning procedure to listen to undirected broadcasting of user data from advertising devices using an advertising physical channel.

The scanning device transmits a scan request to an advertising device through an advertising physical channel in order to request additional data from the advertising device. The advertising device transmits a scan response as a response with respect to the scan request, by including additional user data which has requested by the scanning device through an advertising physical channel.

The scanning procedure may be used while being connected to other BLE device in the BLE piconet.

If the scanning device is in an initiator mode in which the scanning device may receive an advertising event and initiates a connection request. The scanning device may transmit a connection request to the advertising device through the advertising physical channel to start a Bluetooth connection with the advertising device.

When the scanning device transmits a connection request to the advertising device, the scanning device stops the initiator mode scanning for additional broadcast and enters the connected mode.

Discovering Procedure

Devices available for Bluetooth communication (hereinafter, referred to as “Bluetooth devices”) perform an advertising procedure and a scanning procedure in order to discover devices located nearby or in order to be discovered by other devices within a given area.

The discovering procedure is performed asymmetrically. A Bluetooth device intending to discover other device nearby is termed a discovering device, and listens to discover devices advertising an advertising event that may be scanned. A Bluetooth device which may be discovered by other device and available to be used is termed a discoverable device and positively broadcasts an advertising event such that it may be scanned by other device through an advertising (broadcast) physical channel.

In the discovery process, the discoverable device advertises an advertisement event in a general discoverable mode or a limited discoverable mode to notify other peripheral devices of the advertisement Can be.

Each mode can be defined as follows.

General Discoverable Mode: A mode for performing a general discovery procedure, and advertisement events can be advertised to nearby devices for a long time.

Limited Discoverable Mode: A mode for performing a limited or general discovery procedure, and advertisement events can be advertised only in limited conditions. For example, advertisements may be advertised to nearby devices only for a limited time.

Both the discovering device and the discoverable device may have already been connected with other Bluetooth devices in a piconet.

Connecting, Procedure

A connecting procedure is asymmetrical, and requests that, while a specific Bluetooth device is performing an advertising procedure, another Bluetooth device should perform a scanning procedure.

That is, an advertising procedure may be aimed, and as a result, only one device may response to the advertising. After a connectable advertising event is received from an advertising device, a connecting request may be transmitted to the advertising device through an advertising (broadcast) physical channel to initiate connection.

Hereinafter, operational states, that is, an advertising state, a scanning state, an initiating state, and a connection state, in the BLE technology will be briefly described.

Advertising State

A link layer (LL) enters an advertising state according to an instruction from a host (stack). In a case in which the LL is in the advertising state, the LL transmits an advertising packet data unit (PDU) in advertising events.

Each of the advertising events include at least one advertising PDU, and the advertising PDU is transmitted through an advertising channel index in use. After the advertising PDU is transmitted through an advertising channel index in use, the advertising event may be terminated, or in a case in which the advertising device may need to secure a space for performing other function, the advertising event may be terminated earlier.

Scanning State

The LL enters the scanning state according to an instruction from the host (stack). In the scanning state, the LL listens to advertising channel indices.

The scanning state includes two types: passive scanning and active scanning. Each of the scanning types is determined by the host.

Time for performing scanning or an advertising channel index are not defined.

During the scanning state, the LL listens to an advertising channel index in a scan window duration. A scan interval is defined as an interval between start points of two continuous scan windows.

When there is no collision in scheduling, the LL should listen in order to complete all the scan intervals of the scan window as instructed by the host. In each scan window, the LL should scan other advertising channel index. The LL uses every available advertising channel index.

In the passive scanning, the LL only receives packets and cannot transmit any packet.

In the active scanning, the LL performs listening in order to be relied on an advertising PDU type for requesting advertising PDUs and advertising device-related additional information from the advertising device.

Initiating State

The LL enters the initiating state according to an instruction from the host (stack).

When the LL is in the initiating state, the LL performs listening on advertising channel indices.

During the initiating state, the LL listens to an advertising channel index during the scan window interval.

Connection State

When the device performing a connection state, that is, when the initiating device transmits a CONNECT_REQ PDU to the advertising device or when the advertising device receives a CONNECT_REQ PDU from the initiating device, the LL enters a connection state.

It is considered that a connection is generated after the LL enters the connection state. However, it is not necessary to consider that the connection should be established at a point in time at which the LL enters the connection state. The only difference between a newly generated connection and an already established connection is a LL connection supervision timeout value.

When two devices are connected, the two devices play different roles.

An LL serving as a master is termed a master, and an LL serving as a slave is termed a slave. The master adjusts a timing of a connecting event, and the connecting event refers to a point in time at which the master and the slave are synchronized.

Hereinafter, packets defined in an Bluetooth interface will be briefly described. BLE devices use packets defined as follows.

Packet Format

The LL has only one packet format used for both an advertising channel packet and a data channel packet.

Each packet includes four fields of a preamble, an access address, a PDU, and a CRC.

When one packet is transmitted in an advertising physical channel, the PDU may be an advertising channel PDU, and when one packet is transmitted in a data physical channel, the PDU may be a data channel PDU.

Advertising Channel PDU

An advertising channel PDU has a 16-bit header and payload having various sizes.

A PDU type field of the advertising channel PDU included in the heater indicates PDU types defined in Table 1 below.

TABLE 1

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The following advertising channel PDU types are termed advertising PDUs and used in a specific event.

ADV_IND: Connectable undirected advertising event

ADV_DIRECT_IND: Connectable directed advertising event

ADV_NONCONN_IND: Unconnectable undirected advertising event

ADV_SCAN_IND: Scannable undirected advertising event

The PDUs are transmitted from the LL in an advertising state, and received by the LL in a scanning state or in an initiating state.

Scanning PDU

The following advertising channel DPU types are termed scanning PDUs and are used in a state described hereinafter.

SCAN_REQ: Transmitted by the LL in a scanning state and received by the LL in an advertising state.

SCAN_RSP: Transmitted by the LL in the advertising state and received by the LL in the scanning state.

Initiating PDU

The following advertising channel PDU type is termed an initiating PDU.

CONNECT_REQ: Transmitted by the LL in the initiating state and received by the LL in the advertising state.

Data Channel PDU

The data channel PDU may include a message integrity check (MIC) field having a 16-bit header and payload having various sizes.

The procedures, states, and packet formats in the BLE technology discussed above may be applied to perform the methods proposed in this disclosure

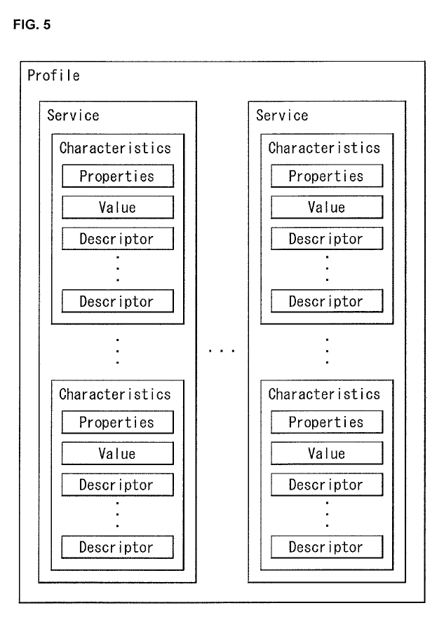

FIG. 5 is a view illustrating an example of a structure of GATT Profile of the Bluetooth low energy.

Referring to FIG. 5, the structure for exchange of Profile Data of the Bluetooth Low Energy is shown.

In detail, the GATT defines a method for exchanging data using a service between Bluetooth LE devices and a characteristic.

In general, a device nearby (for example, a sensor device) serves as a GATT server, and has definition regarding a service and a characteristic.

In order to read or write data, a GATT client sends a data request to the GATT server, and every operation (transaction) is started by the GATT client and a response is received from the GATT server.

A GATT-based operational structure used in the Bluetooth LE may be a vertical structure as illustrated in FIG. 5 on the basis of a profile, a service, and a characteristic.

The profile includes one or more services, and the services may include one or more characteristics or other services.

The service serves to divide data into logical units and may include one or more characteristics or other services, each of the services has a 16-bit or 128-bit identifier called a universal unique identifier (UUID)).

The characteristic is the lowermost unit in the GATT-based operational structure. The characteristic includes only one data, and has a 16-bit or 128-bit UUID, similar to the service.

The characteristic is defined by values of various types of information, and in order to hold each information, an attribute may be required for each information. The characteristic may use several continuous attributes.

The attribute has four components and has meanings as follows.

handle: Address of attribute

Type: Type of attribute

Value: Value of attribute

Permission: Right to access attribute

The present disclosure proposes a method for measuring and storing, by a sensor, human activities using a GATT-based operation structure of Bluetooth low-energy (BLE) and retrieving, by a client, stored information from the sensor.

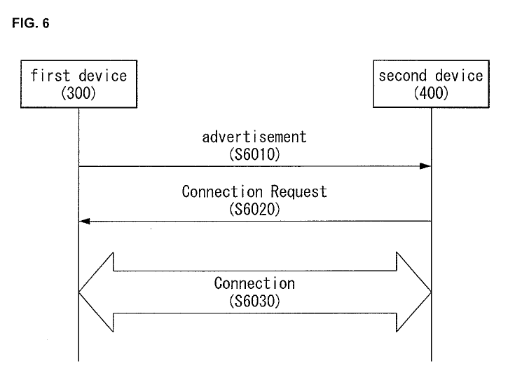

FIG. 6 is a flow chart illustrating a method of forming a connection using BLE between devices.

As illustrated in FIG. 6, for BLE connection between a first device 300 and a second device 400, the first device 300 transmits an advertising message to the second device (S6010).

As described above, the advertising message may be used to provide own information to another device by utilizing BLE, and include various types of information such as service information, user information, and the like, provided by the device.

The second device 400 checks the information included in the advertising message transmitted from the first device 300 and transmits a connection request message for requesting a BLE connection to the first device 300 (S6020), whereby the first device 300 and the second device 400 form a BLE connection (S6030).

If a user interface (UI) is not present in the device 400, formation of a connection cannot be controlled and there is shortcomings in that it is impossible to check a PIN number and control a connection setup.

Thus, in order to solve the problem, the present disclosure proposes a method for forming a connection between the first device 300 and the second device 400 using a third device.

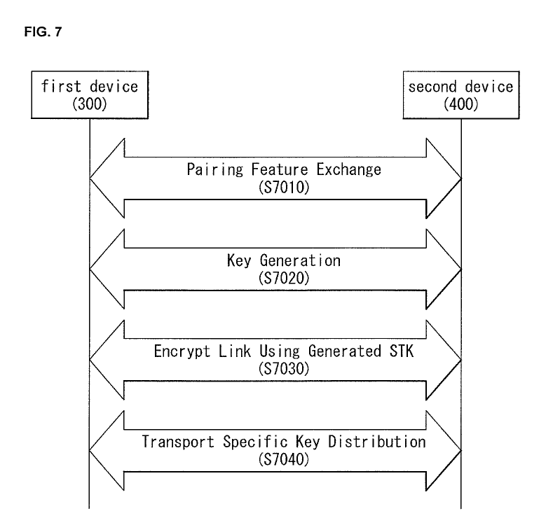

FIG. 7 is a flow chart illustrating a method for performing pairing by a device using BLE.

For security, BLE provides a security manager (SM) 42 as illustrated in FIG. 4. The SM 42 defines pairing, a key distribution method, a security tool therefor, and the like in Bluetooth.

The followings are types of key used for security of Bluetooth.
TK (Temporary Key): It is a 128-bit temporary key used for generating a short term key (STK)
STK (Short Term Key): It is a 128-bit temporary key used for encrypting a connection
LTK (Long Term Key): It is a 128-bit key used for encryption for a reconnection

In Bluetooth, pairing refers to a procedure performed to generate keys used for encrypting a connection.

The pairing procedure includes three steps, and first two steps are always performed and a final step is selectively performed.

Referring to FIG. 7, the Bluetooth pairing procedure may performed by three steps including pairing feature exchange, key generation, and transport specific key distribution

Hereinafter, it is assumed that the first device 300 serves as a master device and the second device 400 serves as a slave device.

Pairing Feature Exchange Procedure (S7010)

The pairing feature exchange is a procedure for exchanging authentication request matters for determining a method to be used in the key generation procedure and information regarding input/output capability.

In detail, in order to request pairing from the second device 400, the first device 300 transmits, to the second device 400, a pairing request message including information related to pairing.

The pairing request message may include information such as input and output (10) capability of the first device, OOB data flag, maximum encryption key size, AuthReq, Initiator key distribution, Responder Key Distribution, and the like.

The second device 400 transmits a pairing response message including pairing-related information as a response to the pairing request message.

Here, the pairing related information may include information such as IO (Input and Output) capability, an OOB data flag, a maximum encryption key size, AuthReq, Initiator key distribution, Responder Key Distribution, and the like, of the second device.

Through the pairing request message and the pairing response message, the first device 300 and the second device 400 determine a communication method to be used in the key generation procedure.

Key Generation Procedure (S7020)

Through the pairing feature exchange procedure, the first device 300 and the second device 400 generate the aforementioned STK by selecting one of four methods as follows.

Numeric Comparison: Numeric Comparison may be used when both two devices have a display capable of displaying 6-digit numbers. Both devices may output the 6-digit numbers on the displays and perform pairing upon receiving permission of pairing when output numbers are the same.

Just Work: Just Work is a method devised for a case (e.g., a cell phone and a headset) where one or more devices does not have a display displaying 6-digit numbers or an input unit for inputting 6-digit numbers.

The Just Work method uses a numeric comparison protocol, but a generated number is not output and only whether to permit pairing may be received from a user.

Passkey Entry: With Passkey Entry method, when certain 6-digit numbers are generated and output through a display unit, another device may receive the numbers and perform pairing.

Out of Band (OOB): Out of Band refers to a method of using an interface other than Bluetooth to exchange pairing information. This method is safer than the Passkey Entry method or the Just Work method but two devices are required to have an interface fit each other.

The first device 300 may generate an encryption link using an STK generated through a key generation procedure with the second device 400 (S7030).

Transport Specific Key Distribution Procedure (S7040)

A transport specific key distribution procedure, the third step, is not essential and is selectively performed, in which an LTK and other necessary keys are discomposed on the basis of information exchanged through the pairing feature exchange procedure.

First, the second device 400 transmits keys to the first device 300, and thereafter, the first device 300 transmits keys to the second device 400.

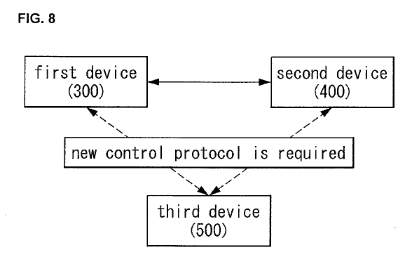

FIG. 8 is a view schematically illustrating a method for controlling formation of a connection between other devices through a control device according to an embodiment of the present disclosure.

As illustrated in FIG. 8, in order to form a connection between the first device 300 and the second device 400, a third device 500 is required, and in order for the third device 500 to control the first device 300 and the second device 400, a new control protocol is required.

Hereinafter, a control device representing a device controlling formation of a connection between the first device 300 and the second device 400 will be referred to as the third device 500.

The third device 500 controls a connection state of other devices (e.g., a Bluetooth device) without using an actual service or a profile.

Here, in order to control a connection state of other devices, the third device 500 should know information (e.g., interface information, service information, etc.) of the other devices.

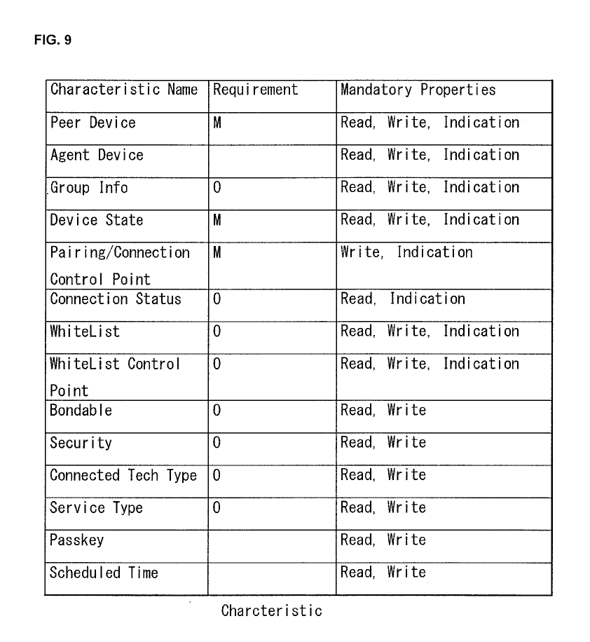

FIG. 9 is a view illustrating an example of characteristics of GATT for controlling a device through a BLE technology according to an embodiment of the present disclosure.

Characteristics included in a GATT database illustrated in FIG. 9 are described as follows.

Peer Device: It uses an address value of a counterpart device to be paired and a name of the device. It may provide an address of the device to be paired through setting of a corresponding value.

Agent device: It may provide information of a control device which is able to control pairing or connection.

Group Info: It uses a name or an address of a group to which a corresponding device belongs. Names or addresses of several groups may be used and whether a corresponding device is a group owner or group member may be identified.

Device State: It refers to scanning, standby, advertising, initiating, and connection state corresponding to a link layer state of a controlled device, and designates one state or several states. A request for performing a corresponding state function may be made through writing, and a current state of a controlled device may be recognized through reading. A change in a state of the controlled device may be recognized through indication.

pairing/connection control point: It is a control point function for indicating which action a controlled device is to execute.

Connection State: It is a characteristic for a controlled device to provide connection information to a control device.

WhiteList: It includes information of devices to which a controlled device is connected, and when necessary, extension allowing connection to several devices is possible.

WhiteList Control Point: It indicates a control function for managing a white list (WhiteList) managed by a controlled device.

Bondable: It may indicate whether a controlled device provides a bonding function.

Security: It indicates whether authentication, authorization, encryption, data signing function is provided.

Connected Tech Type & Service Type: It indicates a technology of a communication type desired to be connected (e.g., WiFi, Ethernet, BR/EDR, BLE, etc.) and a service type.

Passkey: Passkey when a passkey entry method is used.

Scheduled Time: It is a time value for requesting connection at a specific time

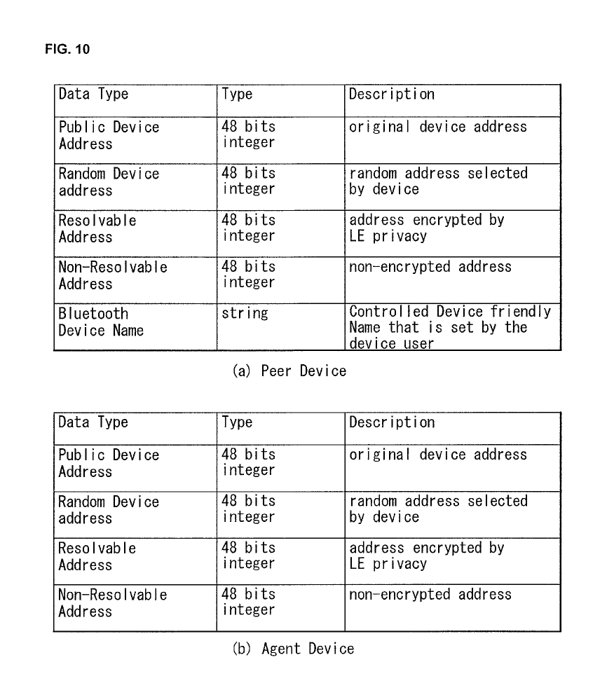

FIG. 10 illustrates an example of Peer Device and Agent Device of the characteristics illustrated in FIG. 9, in which (a) illustrates an example of information of the Peer Device and (b) illustrates an example of information of the Agent Device.

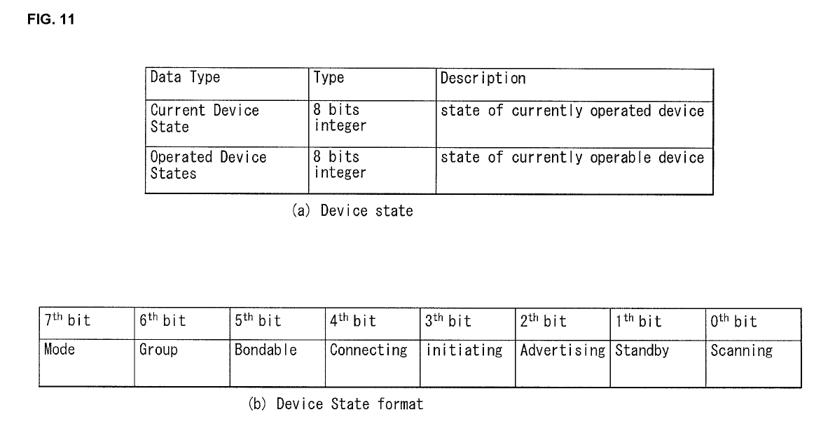

FIG. 11 illustrates an example of a device state of the characteristics illustrated in FIG. 9. A type of a device state may be divided into a current device state representing a current state of a device and an operated device state representing a state of an operable device and may be differentiated through a mode of (b) of FIG. 11. For example, when the mode has a value 0, it may indicate the current device state, and when the mode has a value 1, it may indicate an operated device state.

Here, when the mode indicates the current device state, only one state information indicating a current state of a device, and when the mode indicates the operated device state, several state information indicating several states in which a device is operable.

For example, when the mode indicates the current device state, only one of bits representing a device state illustrated in (b) of FIG. 11 (a value of a specific bit representing a state may be set to 1), and when the mode indicates the operated device state, several bits may be used (multiple bits values may be set to 1).

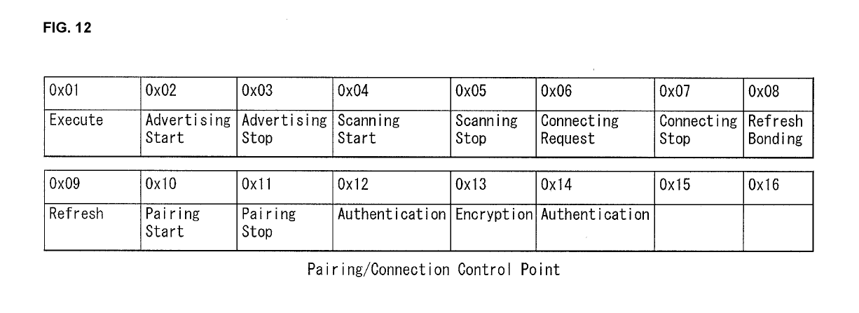

FIG. 12 illustrates an example of pairing/connection control point of the characteristics illustrated in FIG. 9, and the control device may control a device by indicating a specific operation to the device through a pairing/connection control point.

Each operation of the pairing/connection control point illustrated in FIG. 12 may be defined as follows.

Execute: A device provides states defined in a device state (able to provide multiple state functions).

Advertising Start: When an advertising operation is not performed, the corresponding operation starts

(A corresponding function immediately starts and/or if a corresponding state is inactive in a device state, the corresponding function may be activated).

Advertising Stop: When an advertising operation is performed, the corresponding operation is stopped.

(A corresponding function is immediately stopped, and if a corresponding state is active in the device state, the corresponding function may be deactivated)

Scanning Start: If a scanning operation is not performed, the corresponding operation starts.

(A corresponding function immediately starts, and if a corresponding state is inactive in the device state, the corresponding function may be activated)

Scanning Stop: When an advertising operation is performed, the corresponding operation is stopped.

(A corresponding function is immediately stopped, and if a corresponding state is active in the device state, the corresponding function may be deactivated)

Connecting Request: A connection is established with a peer device.

Connection Stop: A connection to peer device is released.

Refresh Bonding: Bonding information is newly updated (or bonding information may be deleted)

Refresh Security: A security procedure (authentication, authorization, encryption) between two devices is performed again and information (key value of each security procedure) is updated.

Pairing Request: A pairing procedure is performed with peer device

Pairing Stop: A pairing procedure with peer device is terminated

Authentication: Authentication is performed with peer device

Encryption: Encryption is performed with peer device

Authorization: Authorization is executed with peer device

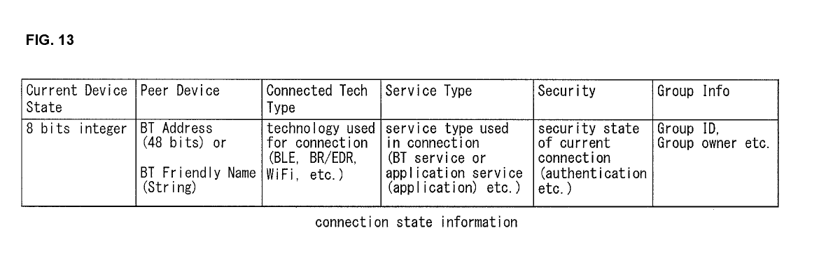

FIG. 13 illustrates an example of a connection status of characteristics illustrated in FIG. 9, and status information of a controlled device may be provided. Here, status information may be provided in the following cases.

Whether connection is available is provided.

Whether connection is available and information of a connected device (address or friendly name of peer device) are provided together

Various states (initiating, advertising, scanning) including connection is provided

In an initiating state, peer device information can be provided together

In an advertising and scanning state, specific information (advertising/scanning method and operation mode) can be provided together

If necessary, information related to connection such as Connected Tech Type, Service Type, Security, and Group Info may also be provided.

Through the connection state, the control device may know a state of the controlled device.

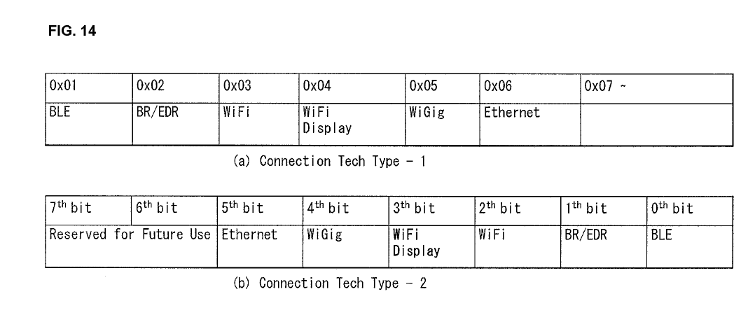

FIG. 14 illustrates two examples of Connection Tech Type of the characteristics illustrated in FIG. 9, through which the control device may control through which communication technology mode the controlled device is connected, and know through which communication technology mode the controlled device has been connected.

The communication technology type illustrated in FIG. 14 is an example and may include various other communication technology modes.

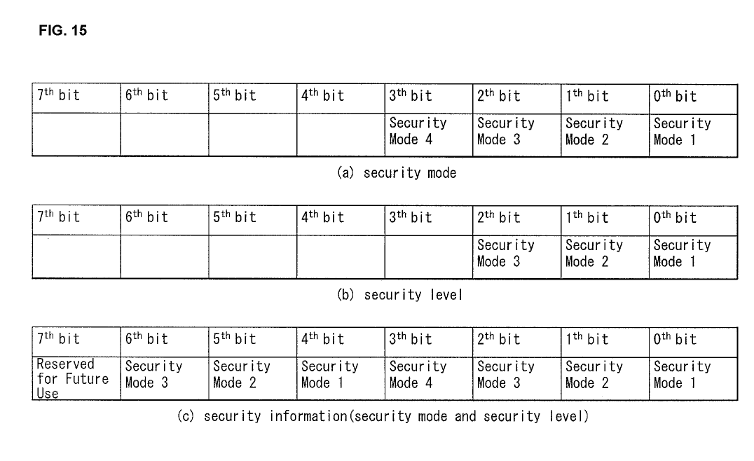

FIG. 15 illustrates an example of security of the characteristics illustrated in FIG. 9, through which a security mode and/or a security level provided in a device may be controlled.

In FIG. 15, (a) illustrates a security mode of a device, (b) illustrates a security level of a device, and (c) illustrates a security mode and a security level.

Whether to provide authentication, authorization, encryption, and data signing may be determined through the security mode and the security level. When security modes and/or security levels are not identical during a process of controlling a connection of two devices, the control device may match the security modes and/or security levels of the two devices through a write message.

The characteristic of the Bluetooth GATT discussed above with reference to FIGS. 9 to 15 may be used in an embodiment of the present disclosure described hereinafter.

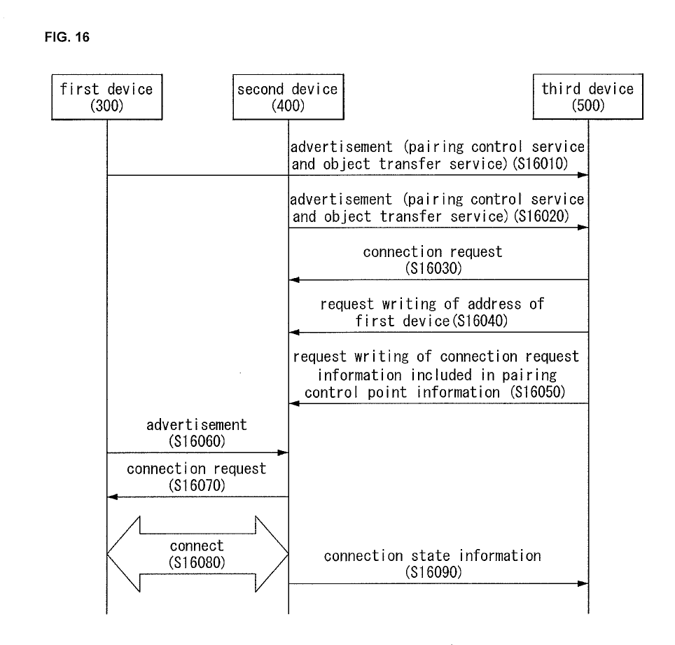

FIG. 16 illustrates an example of a method for controlling a connection of other devices through a control device according to an embodiment of the present disclosure.

Referring to FIG. 16, the third device, a control device, may control connection through the Peer Device and a pairing control point included in the characteristics stored in a GATT database.

In detail, the first device 300 transmits an advertising message to the third device 500 (S16010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, and role information of the first device.

For example, as illustrated in FIG. 15, the first device 300 may include information indicating that the first device 300 provides a pairing control service and an object transfer service and information indicating that the first device 300 serves as a server in the advertising message, and transmit the advertising message to the third device 500.

Here, the pairing control service refers to a service supported in BLE to control a connection of other devices through the control device in Bluetooth communication.

Also, the advertising message may be transmitted to the third device 500 in a broadcast manner or unicast manner.

Like the first device 300, the second device 400 may also transmit an advertising message to the third device 500 (S16020). Like the advertising message transmitted by the first device, the advertising message mat include service information that can be provided by the second device 400, information related to the second device 400, and role information of the second device 400.

Thereafter, the third device 500 transmits a connection request message to form a BLE connection with the second device 400 on the basis of the advertising messages transmitted from the first device 300 and the second device 400 (S16030).

Thereafter, the third device 500, which has formed the connection through BLE with the second device 400, requests writing of an address of the first device 300 in the Peer Device of the characteristics illustrated in FIG. 8 so that the second device 400 may be connected to the first device 300 (S16040).

Here, the third device 500 may provide information of the first device 300 together, when requesting writing.

The third device 500, which has requested the second device 400 to write an address of the first device 300, may indicate connection to the first device 300 by requesting the second device 400 to write to “0x06” of the pairing/connection control point discussed above with reference to FIG. 8 (16050).

Upon receiving the instruction to perform connection to the first device 300 from the third device 500, the second device 400 receives an advertising message from the first device 300 (S16060) and transmits a connection request message to the first device 300 (S16070).

Thereafter, the first device 300 and the second device 400 establish a connection (S16080) and transmit the connection state information described above with reference to FIG. 8 to the third device 500 through an indication message (S16090).

Here, in order for the third device 500 to receive the indication message, the third device 500 should maintain bonding information management and a continuous connection state between the third device 500 and the second device 400

Through this method, the third device 500 may receive the information for controlling connection from the first device 300 and the second device 400 and control connection.

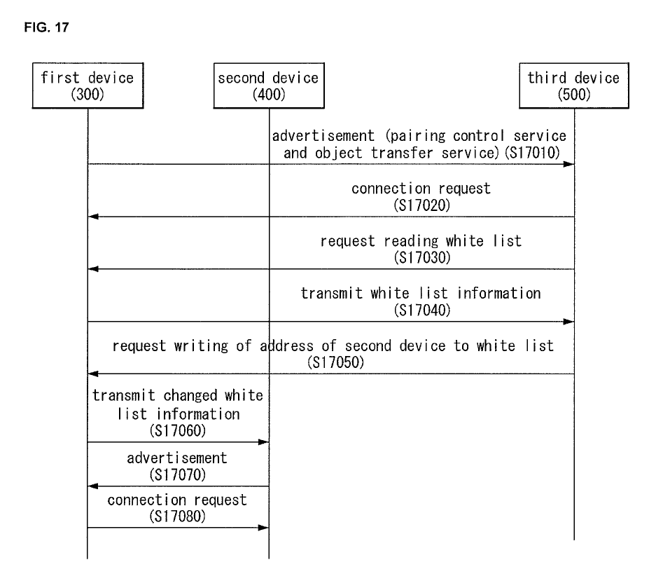

FIG. 17 illustrates another example of a method for controlling a connection of other devices through a control device according to an embodiment of the present disclosure.

Referring to FIG. 17, the third device, a control device, may control connection between the first device and the second device by adding information of the second device to the white list indicating a list of connectable devices of the first device through the connection with the first device.

In detail, the first device 300 transmits an advertising message to the third device 500 (S17010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, and role information of the first device.

For example, as illustrated in FIG. 17, the first device 300 may include information indicating that the first device 300 provides a pairing control service and an object transfer service and information indicating that the first device 300 serves as a server in the advertising message, and transmit the advertising message to the third device 500.

Here, the pairing control service refers to a service supported in BLE to control a connection of other devices through the control device in Bluetooth communication.

Also, the advertising message may be transmitted to the third device 500 in a broadcast manner or unicast manner.

Thereafter, in order to form a BLE connection with the first device 300 on the basis of the advertising message transmitted from the first device 300, the third device 500 transmits a connection request message (S17020).

The third device 500 connected with the first device 300 through BLE requests the first device 300 to read a white list (White list) to obtain white list information indicating a list and/or information of devices to which the first device can be connected (S17030).

In response to the request from the third device 500, the first device 300 transmits the white list information to the third device 500 (S17040).

Here, the white list information may be transmitted through a read response message or a L2CAP channel.

Upon receiving the white list information from the first device 300, when information of the second device 400 is included in the white list information, the third device 500 does not request the first device 300 to register the second device 400.

If, however, information of the second device 400 is not included in the white list information, the third device 500 requests writing of a white list control point (WhiteList Control Point) discussed above with reference to FIG. 8 in order to add the second device 400 to the white list of the first device 300 (S17050).

Here, the third device 500 may transmit information of the second device 400 together in order to add information of the second device 400 to the white list.

The first device may add the information of the second device 400 to the white list and transmit the information of the changed white list to a connected device and/or bonded devices through an indication message (S17060).

Thereafter, when the advertising message is transmitted from the second device 400, the first device 300 transmits a connection request message to the second device 400 so as to be connected with the second device 400 (S17080).

In this manner, the third device 500 may control devices to which the first device 300 can be connected, by adding or deleting device information to or from the white list of the first device.

In another embodiment of the present disclosure, the third device may control a list of devices to which the first device 300 is not connected, by adding or deleting device information to or from a black list (BlackList) different from the white list.

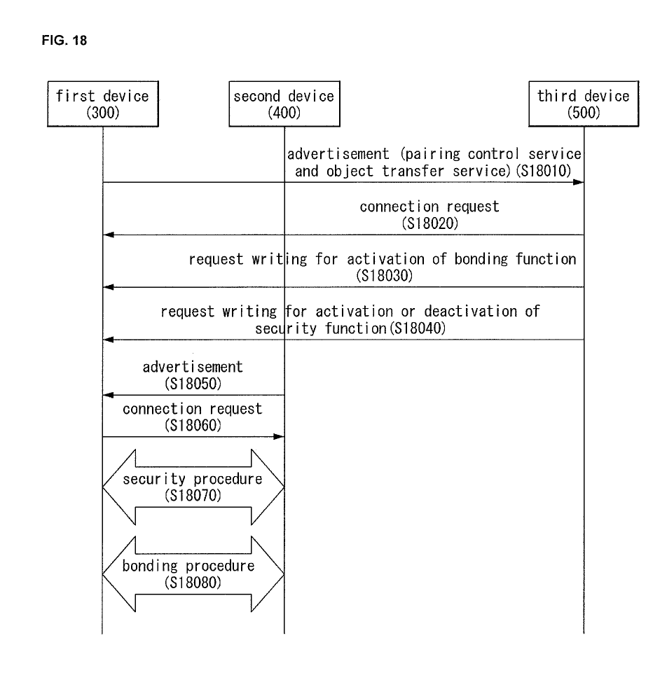

FIG. 18 illustrates another example of a method for controlling connection of other devices through a control device according to an embodiment of the present disclosure.

Referring to FIG. 18, the third device, a control device, may control the first device to perform a security procedure and a bonding procedure with the second device by activating a bonding function or a security function of the first device.

First, step S18010 and step S18020 are the same as step S17010 and step S17020 of FIG. 17, so descriptions thereof will be omitted.

The third device 500 may activate the bonding function of the first device by requesting writing of Bondable to the characteristics illustrated in FIG. 8 (S18030).

When the bonding function is activated, bonding information of connected devices is maintained, and thus, when a re-connection is attempted, the re-connection may be rapidly established without a pairing procedure.

Also, when the third device 500 intents to activate the security function of the first device 300, the third device 500 may request wiring of security illustrated in FIG. 8, thereby activating the security function of the first device 300 (S18040).

Here, a security mode may be set, and the first device 300 may execute a security function (e.g., authentication, authorization, encryption, privacy, etc.) according to the set security mode.

Thereafter, the first device 300 transmits an advertising message to the second device 400 (S18050), and upon receiving the advertising message, the second device 400 transmits a connection request message to the first device 300 so as to be connected to the first device 300 (S18060).

Since the bonding function and security function are activated by the third device 500, the first device 300 connected to the second device 400 performs a security procedure according to a security mode set with the second device 400 (S18070), and performs a bonding procedure according to the set bondable value (S18080).

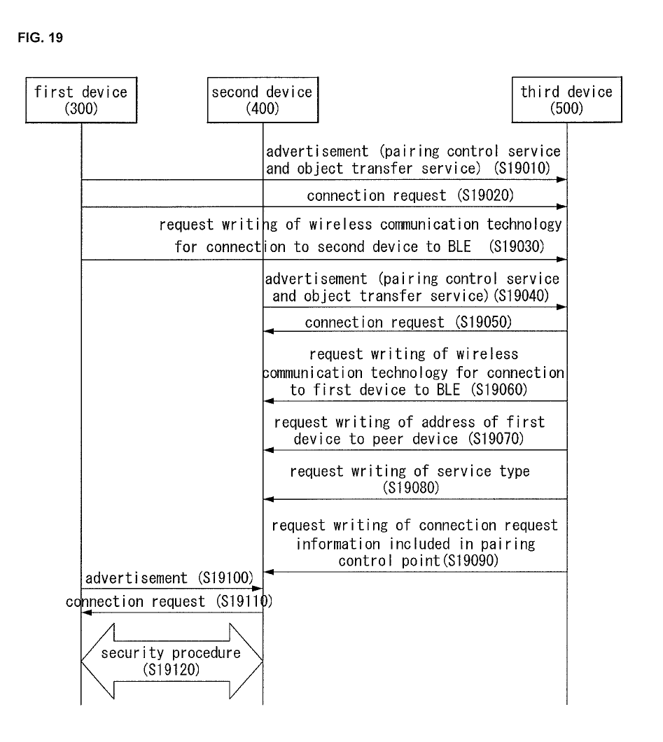

FIG. 19 illustrates another example of a method for controlling a connection of other devices through a control device according to an embodiment of the present disclosure.

Referring to FIG. 19, the third device, a control device, may control the first device such that the first device may be connected to the second device through a specific wireless communication technology.

In detail, the first device 300 transmits an advertising message to the third device 500 (S19010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, role information of the first device and/or type information of a wireless communication technology which can be supported by the first device.

For example, as illustrated in FIG. 15, the first device 300 may include information indicating that the first device 300 provides a pairing control service and an object transfer service, information indicating that the first device 300 serves as a server, and/or information indicating that a type of a wireless communication technology supported by the first device 300 is Bluetooth, LE, Wi-Fi, and NFC, in the advertising message, and transmit the advertising message to the third device 500.

Here, the pairing control service refers to a service supported in BLE to control a connection of other devices through the control device in Bluetooth communication.

Also, the advertising message may be transmitted to the third device 500 in a broadcast manner or unicast manner.

Thereafter, the third device 500 transmits a connection request message to form a BLE connection with the first device 300 on the basis of the advertising message transmitted from the first device 300 (S19020).

The third device 500 which has performed a connection with the first device may request the first device 300 to write Tech Type of the characteristics illustrated in FIG. 8 in order to set a communication technology type based on which the first device is to form a connection with the second device 400 (S19030).

For example, when the third device 500 wants to control the first device 300 to perform connection with the second device 400 through BLE, the third device 500 may request the first device 300 to write to set the Tech Type as BLE.

Thereafter, like the first device 300, the second device 400 transmits an advertising message to the third device 500 (S19040), and the third device 500 transmits a connection request message to the second device 400 to form a connection with the second device 400 (S19050).

Like the advertising message transmitted by the first device 300, the advertising message transmitted by the second device 400 may include service information supported by the second device 400, information related to the first device, role information of the first device, and/or type information of a wireless communication technology which can be supported by the first device.

Like the first device, the third device 500 may request the second device 400 to write to set a Tech Type of the second device to BLE (S19060).

Thereafter, in order to control the second device 400 to be connected to the first device 300, the third device 500 requests writing of an address of the first device 300 in the Peer Device, among the characteristics of the second device 400, and provide information of the first device 300 (S19070).

The third device 500 may request the second device to write a service type to set a service intended to be provided through BLE (S19080). For example, when an object transfer service is intended to be provided through connection between the second device 400 and the first device 300, the third device 500 may transmit a write request message requesting setting a service type to the object transfer service, to the second device 400.

After setting the service type, the third device 500 may request the second device writing to ‘0x06’ of Pairing/Connection Control Point so that the second device 400 may perform a connection procedure with the first device 300 (S19090).

Upon being instructed by the third device 500 to transmit a connection request to the first device 300 through writing to the Pairing/Connection Control Point, the second device 400 receives an advertising message from the first device (S19100) and subsequently transmits a connection request message to the first device to form a BLE connection with the first device (S19110, S19120).

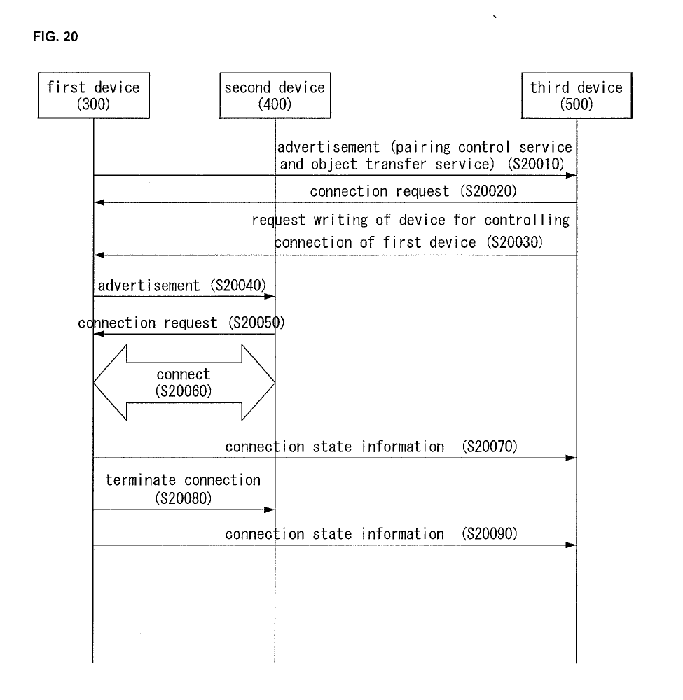

FIG. 20 illustrates another example of a method for controlling a connection of other devices through a control device according to an embodiment of the present disclosure.

Referring to FIG. 20, after the third device, a control device, controls the first device to be connected to the second device, if a connection stage between the first device and the second device is changed, the third device may receive connection state information.

First, step S20010 and step S20020 are the same as step S19010 and step S19020 of FIG. 17, so descriptions thereof will be omitted.

When the third device 500 is connected to the first device 300, in order to set a device for controlling pairing/connection of the first device, the third device 500 requests the first device 300 to write an address of a device for controlling pairing/connection, to the Agent Device (S20030).

Hereinafter, it will be described that the third device 500 is a device for controlling pairing/connection in an embodiment of the present disclosure, for example.

Thereafter, the first device 300 transmits an advertising message including service information which can be provided by the first device 300, to the second device 400 (S20040), and upon receiving the advertising message, the second device 400 transmits a connection request message to the first device 300 to form a connection with the first device 300 (S20050, S20060).

As the first device 300 forms a connection with the second device 400, a connection state of the first device 300 is changed, and thus, the first device 300 transmits changed connection state information to the third device, a device set in the Agent Device, through an indication message (S20070).

Here, the connection state information may include information of a device state, a characteristic representing a current state of the first device described above with reference to FIG. 10, information of the Peer Device, a characteristic including information of the second device as a counterpart device, and the like.

In order for the third device 500 to receive the indication message, bonding information management and a connection state with the first device 300 should be maintained.

Thereafter, the first device 300 transmits a connection termination message to the second device to terminate the connection with the second device 400 (S20080).

When the connection to the second device 400 is terminated, a connection state of the first device 300 has been changed, and thus, the first device 300 transmits the changed connection state information to the third device 500, a device set in the Agent Device, through an indication message (S20090).

Here, the connection state information may include information of a device state, a characteristic representing a current state of the first device described above with reference to FIG. 10, information of the Peer Device, a characteristic including information of the second device 400, a device terminated in connection, and the like.

As described above, in order for the third device 500 to receive the indication message, bonding information management and a connection state with the first device 300 should be maintained.

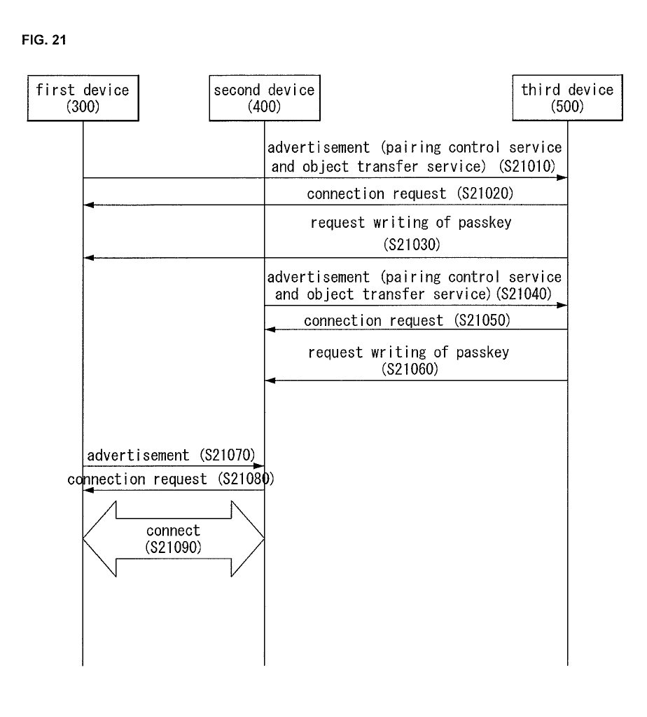

FIG. 21 illustrates another example of a method for controlling a connection of other devices through a control device according to an embodiment of the present disclosure.

Referring to FIG. 21, the third device, a control device, may set an authentication key for a connection to the first device and the second device, and the first device and the second device may authenticate each other using the set authentication key.

First, step S21010 and step S21020 are the same as step S19010 and step S19020 of FIG. 19, so descriptions thereof will be omitted.

When the first device 300 supports secure simple pairing (SSP), the third device 500 may request the first device 300 to write a passkey in order to set a passkey to be used for the SSP (S21030).

The SSP refers to a pairing method using a public key encryption form, rather than pairing using an existing PIN code, supporting a function to easily perform pairing. The passkey represents an authentication key used in the SSP, and devices supporting the SSP may authenticate a counterpart device by exchanging and comparing the passkeys.

Thereafter, in order to set a passkey to the second device 400 to perform a connection with the first device 300, the third device 500 may perform a connection procedure with the second device 400.

First, like the first device 300, the second device 400 transmits an advertising message to the third device 500 (S21040). Like the advertising message transmitted by the first device 300, the advertising message may include service information supported by the second device 400, information related to the second device, role information of the first device, and/or type information of a wireless communication technology which can be supported by the first device.

Here, the advertising message may be transmitted to the third device 500 in a broadcast manner or unicast manner.

Next, the third device 500 transmits a connection request message for forming a BLE connection with the second device 400 on the basis of the advertising message transmitted from the second device 400 (S21050).

Thereafter, the third device 500 connected to the second device 400 requests the second device 400 to write a passkey to set the same passkey of the second device 400 as that of the first device (S21060).

In this manner, the same passkey for performing SSP with the first device 300 may be set in the second device 400.

Thereafter, the first device 300 transmits an advertising message including service information to the second device 400 (S21070), and the second device receives the advertising message from the first device 300 and transmits a connection request message to the first device 300 to perform a connection procedure with the first device 300 (S21080).

The first device 300 and the second device 400 perform an authentication procedure for connection, and when the passkey of the first device 300 and the passkey of the second device 400 are the same, authentication is successful, and when the passkey of the first device 300 and the passkey of the second device 400 are not identical, authentication may fail (S21090).

In this manner, the control device may control the authentication procedure of the devices by setting the passkeys of the devices to be controlled in connection.

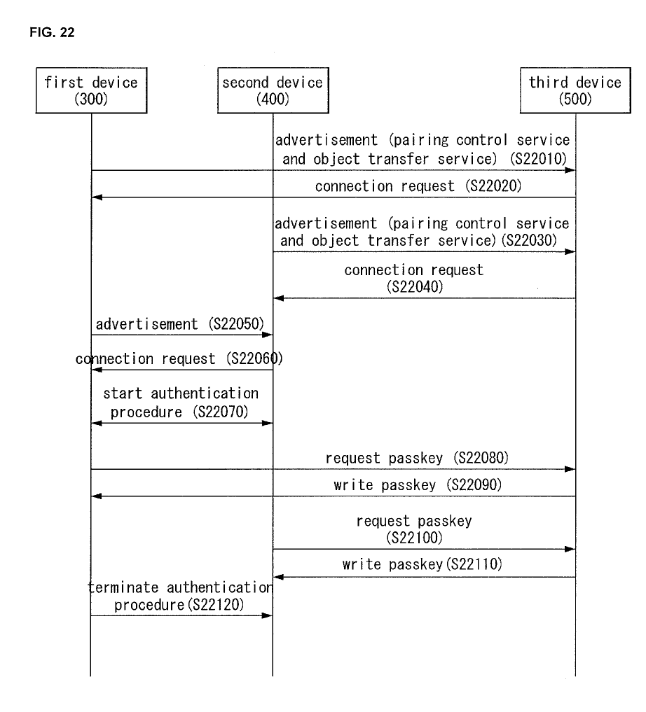

FIG. 22 illustrates another example of a method for controlling a connection of other devices through a control device according to an embodiment of the present disclosure.

Referring to FIG. 22, unlike the case of FIG. 20, the first device and the second device may request the third device, a control device, to set a passkey, and perform the authentication procedure through a set passkey.

First, step S22010 and step S22020 are the same as step S19010 and step S19020 of FIG. 19, so descriptions thereof will be omitted.

Next, the third device 500 receives an advertising message from the second device 400 (S22030).

Like the advertising message transmitted by the first device 300, the advertising message may include service information supported by the second device 400, information related to the second device, role information of the first device, and/or type information of a wireless communication technology which can be supported by the first device.

Here, the advertising message may be transmitted to the third device 500 in a broadcast manner or unicast manner.

Thereafter, the third device 500 transmits a connection request message for forming a BLE connection with the second device 400 on the basis of the advertising message transmitted from the second device 400 (S21050), so as to be connected to the second device (S22040).

When the first device 300 and the second device 400 are connected to the third device 500, the first device 300 transmits an advertising message including supported service information to the second device 400 (S22050) and the second device transmits a connection request message to the first device 300 in order to be connected to the first device 300 (S22060).

Thereafter, the first device 300 and the second device 400 start an authentication procedure for authenticating mutual devices (S22070). In order to perform the authentication procedure, the first device 300 requests a passkey required for authentication from the third device 500 (S22080), and the third device 500 writes the passkey to the first device 300 in response to the request (S22090).

In order to perform an authentication procedure like the first device 300, the second device 400 also requests a passkey required for authentication from the third device 500 (S22100), and the third device writes a passkey to the second device 300 in response to the request (S22110).

The first device 300 and the second device 400, to which the passkeys are set from the third device 500, compare mutual passkeys, and when the passkeys are the same, authentication is successful, and when the passkeys are not identical, the authentication procedure is terminated with the authentication failed (S22120).

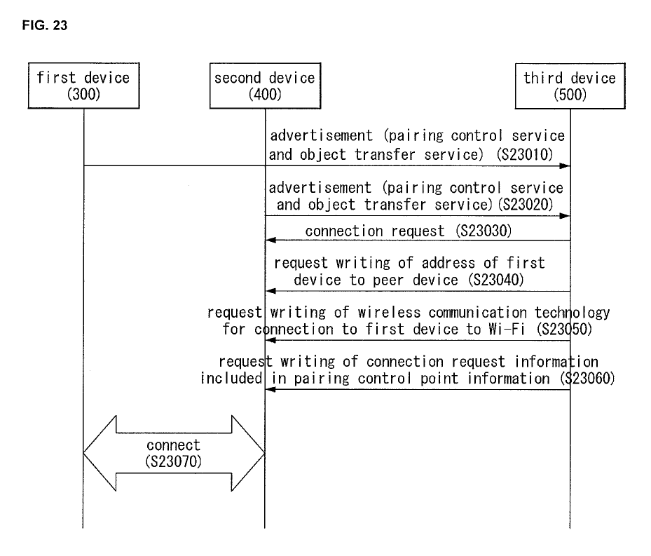

FIG. 23 illustrates another example of a method for controlling a connection of other devices through a control device according to an embodiment of the present disclosure.

Referring to FIG. 23, the third device, a control device, may control the first device and the second device to be connected through a specific wireless communication technology.

First, step S23010 and step S23020 are the same as step S16010 to step S16040 of FIG. 16, so descriptions thereof will be omitted.

When the third device 500 is connected to the second device 400, the third device 500 may request writing of a specific wireless communication technology to Tech Type of the characteristic in order to set a wireless communication technology for the second device 400 to be connected to the first device 300 (S23050). Hereinafter, it is described that the wireless communication technology is assumed to be Wi-Fi, for example.

After setting the Tech Type of the characteristic to Wi-Fi, the third device 500 may request the second device 400 to write ‘0x06’ representing performing of a connection request of pairing/connection control point characteristic in order to instruct the second device 400 to perform a connection procedure with the first device 300 through Wi-Fi (S 23060).

Upon being instructed by the third device 500 to perform connection with the first device 300 through Wi-Fi, the second device 400 performs connection with the first device 300 through Wi-Fi (S23070).

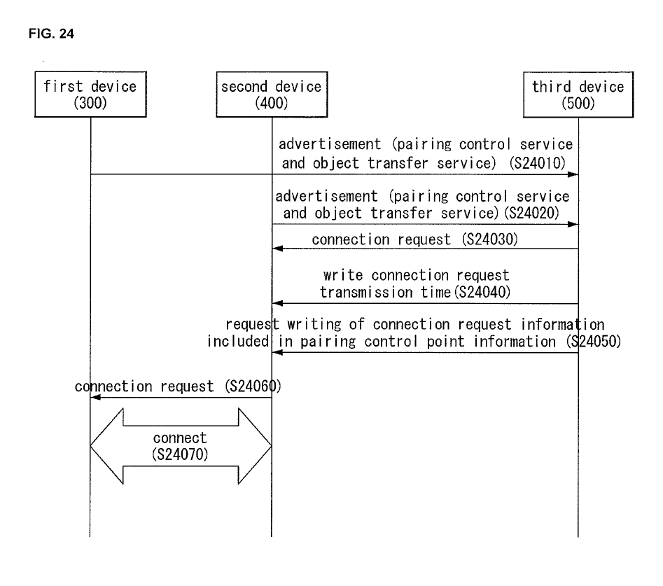

FIG. 24 illustrates another example of a method for controlling a connection of other devices through a control device according to an embodiment of the present disclosure.

Referring to FIG. 24, the third device may control the second device or the first device to perform connection at a specific time.

First, step S24010 to step S24020 are the same as step S16010 to step S19030 of FIG. 16, so descriptions thereof will be omitted.

When the third device 500 is connected to the second device 400, the third device 500 may request writing of scheduled time characteristic to set a time for the second device 400 to transmit a connection request message and request writing of paring/connection control point characteristic to indicate a connection request (S24050).

Thereafter, at the time written to the scheduled time characteristic, the second device 400 transmits a connection request message to the first device 300 for connection with the first device 300 (S24060) and is connected to the first device (S24070).

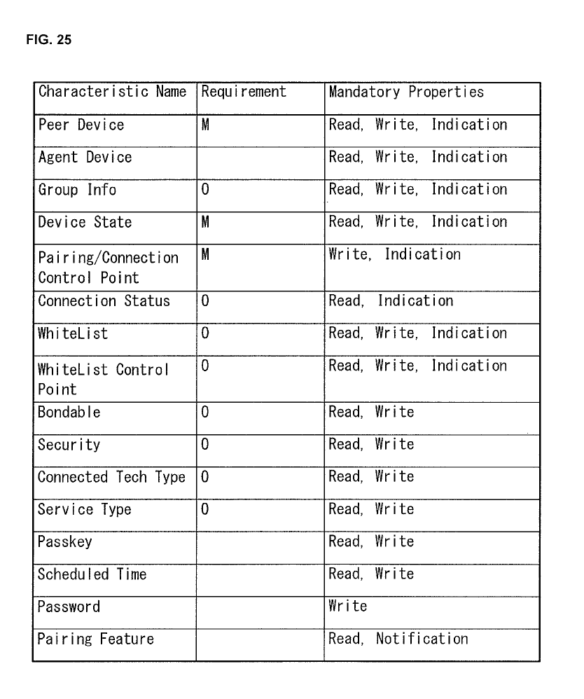

FIG. 25 is a view illustrating another example of characteristics of GATT for controlling a device through a BLE technology according to an embodiment of the present disclosure.

Referring to FIG. 25, in order for a device to control pairing other devices through Bluetooth, the device may set a password to characteristics of GATT, and when the set password is input, an operation of the other devices may be controlled.

Among characteristics included in the GATT database illustrated in FIG. 25, characteristics not described with reference to FIG. 8 will be described as follows.

Password: A password for right of a specific user or device

Pairing Feature: Supported characteristic information

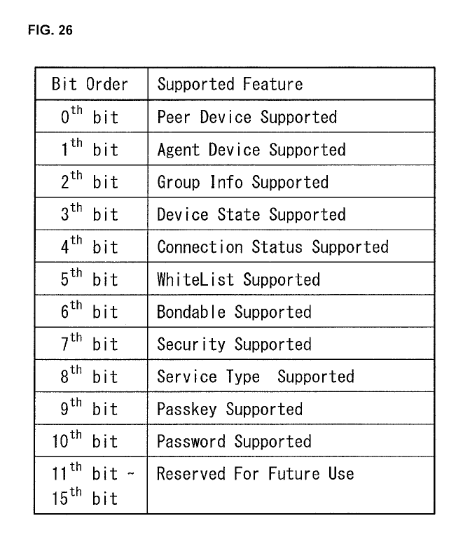

FIG. 26 is a view illustrating an example of characteristic information representing characteristics provided by a device according to an embodiment of the present disclosure.

Referring to FIG. 26, a device may include the characteristic information in an advertising message and transmit the same to a device nearby to thereby information the peripheral control device about characteristics of GATT that can be provided to by the device.

Also, the characteristic information illustrated in FIG. 26 may be an example of Pairing Feature of FIG. 24.

The characteristic information may be expressed in the form of bit, and the control device may know which function of the device it can control through the characteristic information.

Peer Device Supported: Whether information of a target to be paired can be provided (It can be utilized as an id of default connected device)

Agent Device Supported: Whether information regarding a specific agent device can be registered

Group Info Supported: Whether information for controlling connection regarding a group of specific devices can be provided.

Device State Supported: Whether information regarding a state provided in a link layer of a controlled device is provided.

Connection Status Supported Pairing/Connection Control Point: Whether connection information (connection state or pairing state) of controlled device is provided

WhiteList Supported: It is information indicating whether WhiteList of the controlled device is controllable. When the WhiteList is controllable, a device may be added or deleted using the WiteList Control Point.

Bondable Supported: It is information indicating whether corresponding information can be provided to utilize bonding information when a device is connected, or whether the corresponding information can be directly controlled. When the bonding information is provided, authentication step may not be performed when the corresponding information is used for connection.

Security Supported: It indicates whether a function for setting whether authentication, authorization, encryption, and data signing functions are utilized when connected.

Passkey Supported: It is information indicating whether a passkey entry method is supported and whether a passkey characteristic is supported when a device is connected.

Password Supported: It is information indicating whether control is possible using a password or whether a password has been set.

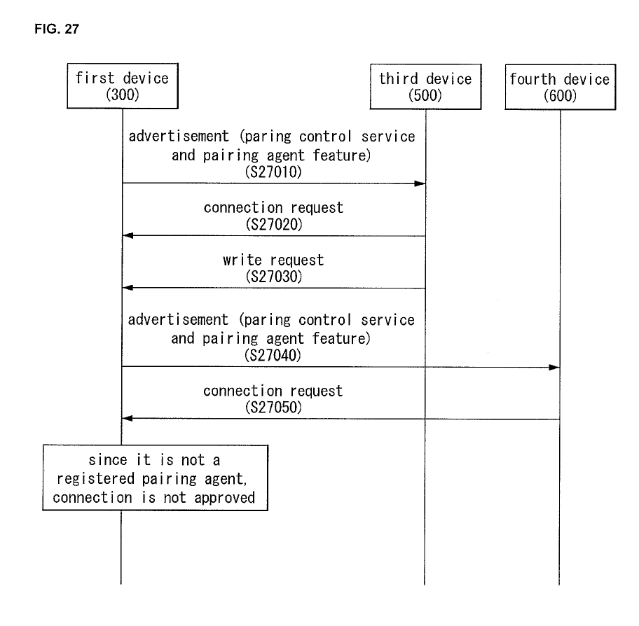

FIG. 27 is a view illustrating an example of a method for setting a control device according to an embodiment of the present disclosure.

Referring to FIG. 27, in cases where a control device set in the characteristic requests connection for controlling a device, the control device may be connected to a controlled device, but a control device which has not been set cannot be connected.

In detail, a controlled device (hereinafter, referred to as a “first device 300”) transmits an advertising message to the third device 500 (S27010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, role information of the first device, and/or the characteristic information discussed above with reference to FIG. 25.

For example, as illustrated in FIG. 15, the first device 300 may set information indicating that the first device 300 provides pairing control service and 1^{st} bit corresponding to and “Agent Device Supported” of the characteristic information to ‘1’ in the advertising message and transmit the same to the third device.

Here, the pairing control service refers to a service supported in BLE to control a connection of another device through a control device in Bluetooth communication.

Also, the advertising message may be transmitted to the third device 500 in a broadcast manner or unicast manner.

Upon receiving the advertising message, the third device 500 may recognize that the first device 300 can register information regarding a pairing control service and an agent device.

The third device 500 transmits a connection request message to form a BLE connection with the first device 300 on the basis of the advertising message transmitted from the first device 300 (S27020).

Thereafter, the third device 500 and the first device 300 may perform a connection procedure so as to be connected through BLE.

When the third device 500 is connected to the first device 300 through BLE, the third device 500 transmits a write request message requesting writing of information (e.g., an address value) of the first device 300 to “Agent Device” characteristic indicating a control device of the first device 300 (S27030).

Upon receiving the write request message, the first device 300 writes information of the third device 500 to the “Agent Device” characteristic indicating a pairing control device of the characteristic illustrated in FIG. 24.

Thereafter, the first device transmits the advertising message described in step S27010 to a device nearby (S27040).

When a fourth device 600 receives the advertising message, the fourth device 600 may recognize that the first device 300 supports the pairing control service through the advertising message, and transmits a connection request message to the first device to control pairing of the first device 300 (S27050).

Upon receiving the connection request message, the first device 300 may compare device information input to the “Agent Device” with the information of the fourth device 600 in order to determine connection with the fourth device 600.

According to a comparison result, since the information of the fourth device 600 is different from the information input to the “Agent Device”, the connection request from the fourth device 600 is not accepted.

In this manner, connection of the control device capable of controlling pairing of a device may be controlled.

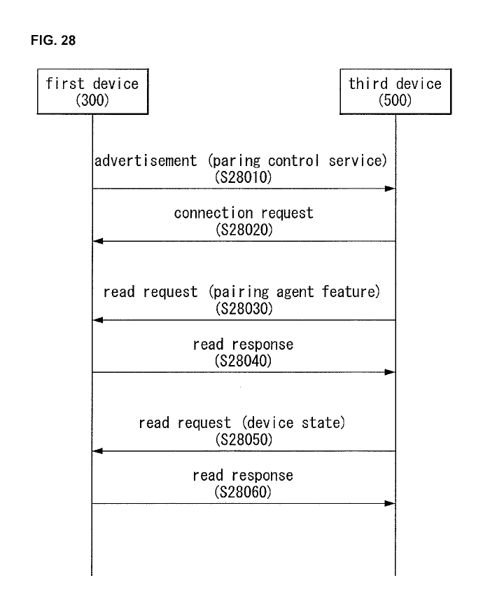

FIG. 28 is a view illustrating an example of a method for transmitting and receiving state information of a device according to an embodiment of the present disclosure.

Referring to FIG. 28, the control device may receive information related to a characteristic of a controlled device and recognize a state of the controlled device.

In detail, the first device 300 transmits an advertising message to the third device 500 (S28010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, role information of the first device, and the like.

For example, as illustrated in FIG. 15, the first device 300 may include information indicating that the first device 300 provides a pairing control service in the advertising message.

Also, the advertising message may be transmitted to the third device 500 in a broadcast manner or unicast manner.

The third device 500 transmits a connection request message to the first device 300 to control the first device 300 (S28020).

Upon receiving the connection request message, the first device 300 may perform a connection procedure with the third device and connected through BLE.

When the third device 500 is connected to the first device 300 through BLE, the third device 500 transmits a read request message of “Pairing Feature” illustrated in FIG. 24 to the first device 300 (S28030).

Upon receiving the read request message, the first device 300 includes “Pairing Feature” in a read response message and transmits the same to the third device 500, as a response thereto (S28040).

The “Pairing Feature” may be the format illustrated in FIG. 25, and here, a bit of “Device State Supported” may be set to “1”.

Through the “Pairing Feature”, it can be recognized that the first device 300 provides state information of device.

Thereafter, the third device 500 transmits a read request message to the first device 300 in order to request “Device State” characteristic value representing a device state (S28050).

Upon receiving the read request message, the first device 300 transmits a read response message including “Device State” characteristic value including state information supported by the first device 300 and current state information of the first device to the third device (S28060).

Upon receiving the read response message, the third device 500 may recognize the state information supported by the first device and the current state of the first device 300.

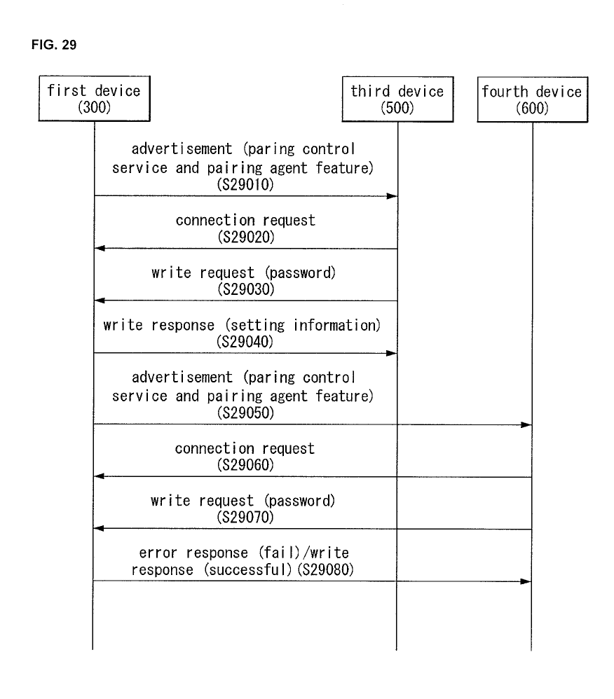

FIG. 29 is a view illustrating an example of a method for setting a password for controlling a device according to an embodiment of the present disclosure.

Referring to FIG. 29, a password may be set in a characteristic for controlling a device, and only when passwords are the same, the control device may control a controlled device.

In detail, the controlled device (hereinafter, referred to as the “first device 300”) transmits an advertising message to the third device 500 (S29010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, role information of the first device, and/or the characteristic information discussed above with reference to FIG. 26.

For example, as illustrated in FIG. 15, the first device 300 may set information indicating that the first device 300 provides a pairing control service and 10th bit corresponding to “Password Supported” of the characteristic information to ‘0’ in the advertising message, and transmit the same to the third device 500.

Here, when the 10^{th} bit is set to ‘0’, it may indicate that a function for setting a password is supported but a password has not been set.

The pairing control service refers to a service supported in BLE to control a connection of another device through a control device in BLE.

Also, the advertising message may be transmitted to the third device 500 in a broadcast manner or unicast manner.

Upon receiving the advertising message, the third device 500 may recognize that the first device 300 supports password characteristic but a password has not been set.

The third device 500 transmits a connection request message to form a BLE connection with the first device 300 on the basis of the advertising message transmitted from the first device 300 (S29020).

Thereafter, the third device 500 and the first device 300 may perform a connection procedure so as to be connected through BLE.

When the third device 500 is connected to the first device 300 through BLE, the third device 500 transmits a write request message requesting writing of a password (first password) to “Password” characteristic to the first device 300 to set a password of the first device 300 (S29030).

Hereinafter, a case where the password is ‘1234’ will be described as an example.

When the first device 300 receives the write request message, the first device 300 transmits a write response message including setting information (or configuration information) indicating whether ‘1234’ has been written as the password (first password) to the “Password” characteristic, to the third device 500 (S29040).

When the password is successfully written, the setting information indicates that the password has been successfully written, and when the password is not written, the setting information indicates that the password has been written.

Thereafter, the first device 300 transmits an advertising message to the fourth device 600 (S29050). The advertising message may be expressed as an advertisement pack data unit (PDU), an advertisement packet, an advertisement, an advertisement frame, an advertisement physical channel PDU, and the like.

The advertising message may include pairing service information supported by the first device 300 and/or the characteristic information discussed above with reference to FIG. 25.

For example, as illustrated in FIG. 15, the first device 300 may set information indicating that the first device 300 provides a pairing control service and 10th bit corresponding to “Password Supported” of the characteristic information to ‘1’ in the advertising message, and transmit the same to the third device 500.

Here, when the 10^{th} bit is set to ‘1’, it may indicate that the function for setting a password is supported and a password has been set.

Also, the advertising message may be transmitted to the third device 500 in a broadcast manner or unicast manner.

Upon receiving the advertising message, the fourth device 600 may recognize that the first device 300 supports password characteristic and a password has been set.

The fourth device 600 transmits a connection request message to form a BLE connection with the first device 300 on the basis of the advertising message transmitted from the first device 300 (S29060).

Thereafter, the fourth device 600 and the first device 300 may perform a connection procedure so as to be connected through BLE.

When the fourth device 600 is connected to the first device 300 through BLE, the fourth device 600 transmits a write request message requesting writing of a specific operation to the “Pairing/Connection Control Point” characteristic illustrated in FIG. 8 or 24 to the first device 300 to instruct the specific operation to the first device 300 (S29070).

The write request message may include instruction information instructing the specific operation and a second password.

Upon receiving the write request message, the first device 300 compares the first password and the second password.

When the first password and the second password are different according to a comparison, the first device 300 transmits an error response message including result information that the password was different so writing to the “Pairing/Connection Control Point” characteristics failed.

However, when the first password and the second password are the same, the first device 300 transmits a write response message including result information indicating that the password was the same so writing to the “Pairing/Connection Control Point” characteristics was successful and performs the specific operation (S29080).

In this manner, a password for controlling a device may be set and an operation of a device may be controlled only when a password is the same.

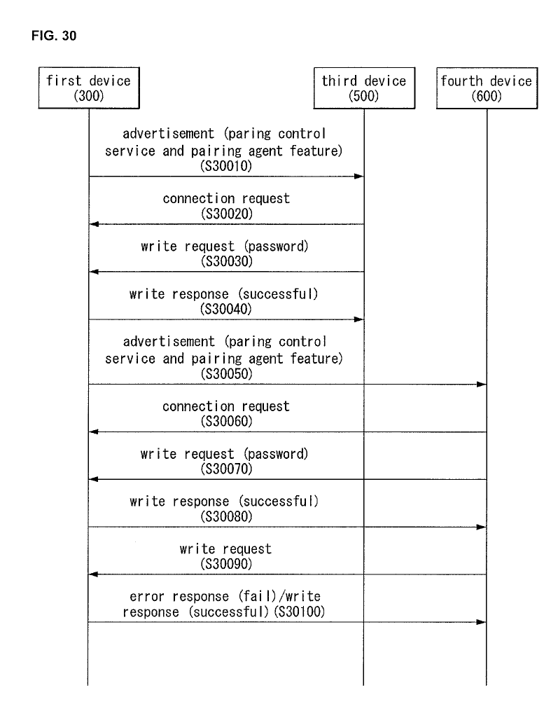

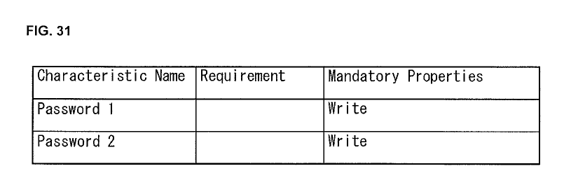

FIGS. 30 and 31 are views illustrating another example of a method for setting a password for controlling a device and characteristics according to an embodiment of the present disclosure.

Referring to FIGS. 30 and 31, when the password 1 and the password 2 of the characteristic are not the same, every request transmitted from a device may be rejected, and when the password 1 and the password 2 are the same, a device may be controlled although a password is not input.

The characteristics illustrated in FIG. 31 are characteristics including “Password 1” and “Password 2”, instead of the “Password” characteristic.

First, step S30010 and step S30020 are the same as step S29010 and step S29020 of FIG. 29, so descriptions thereof will be omitted.

Thereafter, the third device 500 and the first device 300 perform a connection procedure so as to be connected through BLE.

When the third device 500 is connected to the first device 300 through BLE, the third device 500 transmits a write request message requesting writing of a password (first password) to the “Password 1” characteristic of FIG. 30 in order to set a password of the first device 300 (S30030).

Upon receiving the write request message, the first device 300 transmits a write response message including setting information indicating whether a password (first password) was written to the “Password 1” characteristic, to the third device 500 (S30040).

When the password was successfully written, the setting information indicates that the password was successfully written, and when the password was not written, the setting information indicates that the password was not written.

Thereafter, the first device 300 transmits an advertising message to the fourth device 600 (S30050). The advertising message may be expressed as an advertisement pack data unit (PDU), an advertisement packet, an advertisement, an advertisement frame, an advertisement physical channel PDU, and the like.

The advertising message may include pairing control service information supported by the first device 300 and/or the characteristic information discussed above with reference to FIG. 25.

For example, as illustrated in FIG. 15, the first device 300 may set information indicating that the first device 300 provides a pairing control service and 10th bit corresponding to “Password Supported” of the characteristic information to ‘1’ in the advertising message, and transmit the same to the third device 500.

Here, when the 10^{th} bit is set to ‘1’, it may indicate that the function for setting a password is supported and a password has been set.

Also, the advertising message may be transmitted to the third device 500 in a broadcast manner or unicast manner.

Upon receiving the advertising message, the fourth device 600 may recognize that the first device 300 supports password characteristic and a password has been set.

The fourth device 600 transmits a connection request message to form a BLE connection with the first device 300 on the basis of the advertising message transmitted from the first device 300 (S30060).

Thereafter, the fourth device 600 and the first device 300 may perform a connection procedure so as to be connected through BLE.

When the fourth device 600 is connected to the first device 300 through BLE, the fourth device 600 transmits a write request message requesting writing of a second password to “Password 2” characteristic of the first device illustrated in FIG. 30 (S30070).

Upon receiving the write request message, the first device 300 transmits a write response message including setting information indicating whether the second password was written to the “Password 2”, to the third device 500 (S30080).

When the password was successfully written, the setting information indicates that the password was successfully written, and when the password was not written, the setting information indicates that the password was not written.

Thereafter, in order to indicate a specific operation to the first device 300, the fourth device 600 transmits a write request message requesting writing of a specific operation to the “Pairing/Connection Control Point” characteristic illustrated in FIG. 8 or 24 to the first device 300 (S30090).

The write request message may include indication information indicating the specific operation.

Upon receiving the write request message, the first device 300 compares the password 1 written to the “Password 1” characteristic and the password 2 written to the “Password 2” characteristic.

When the first password and the second password are different, the first device 300 transmits an error response message including result information indicating that the passwords are different so writing to the “Pairing/Connection control Point” characteristic failed, to the fourth device 600.

However, when the first password and the second password are the same, the first device 300 transmits a write response message including result information indicating that the passwords were the same so writing to the “Pairing/Connection control Point” characteristic was successful, to the fourth device 600, and performs the specific operation (S30100).

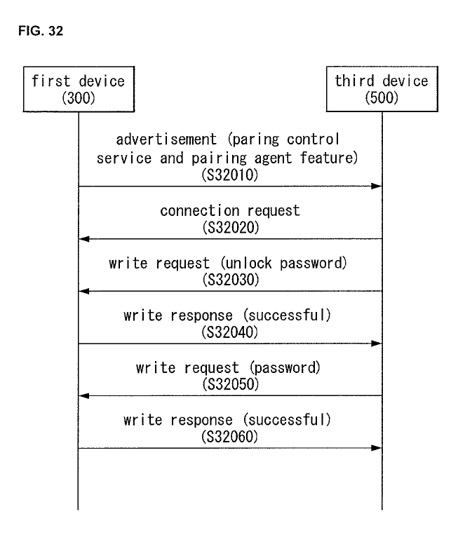

FIG. 32 is a view illustrating an example of a method for changing a password according to an embodiment of the present disclosure.

Referring to FIG. 32, the control device may release a password set in the controlled device and reset a password.

In detail, it is assumed that the first device 300 to which a password was set through the method described above with reference to FIG. 29 or 30 is terminated in connection to the third device after setting the password.

Thereafter, the first device 300 transmits an advertising message to the third device 500 (S32010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, role information of the first device, and/or the characteristic information discussed above with reference to FIG. 26.

For example, as illustrated in FIG. 15, the first device 300 may set information indicating that the first device 300 provides a pairing control service and 10th bit corresponding to “Password Supported” of the characteristic information to ‘1’ in the advertising message, and transmit the same to the third device 500.

Upon receiving the advertising message, the third device 500 may recognize that the first device 300 supports password characteristic and a password has not been set.

In order to release or change the password set in the first device 300, the third device 500 transmits a connection request message to the first device 300 and is connected to the first device 300 through BLE (S32020).

In order to request release of the password set in the first device, the third device 500 connected to the first device 300 through BLE transmits a write request message to the first device (S32030).

Here, the write request message may include an unlock password (first unlock password), a password for releasing the password.

Upon receiving the write request message, the first device 300 compares the received unlock password with an unlock password (second unlock password) previously set in the first device 300.

When the first unlock password and the second unlock password are the same according to a comparison result, the first device releases the previously set password and transmits a write response message including release information indicating that the password was successfully released, to the third device (S32040).

However, when the first unlock password and the second unlock password are different according to the comparison result, the first device does not release the previously set password and transmits an error response message including release information indicating the releasing the password failed, to the third device.

After the third device 500 released the password set in the first device in step S32040, the third device 500 transmits a write request message requesting writing of a password to the “Password” characteristic to the first device in order to reset a password (S32050).

Upon receiving the write request message, the first device 300 transmits a write response message including setting information indicating whether the password was written to the “Password” characteristic, to the third device 500 (S32060).

When the password was successfully written, the setting information indicates that the password was successfully written, and when the password was not written, the setting information indicates that the password was not written.

In this manner, the third device may release the previously set password and reset a new password.

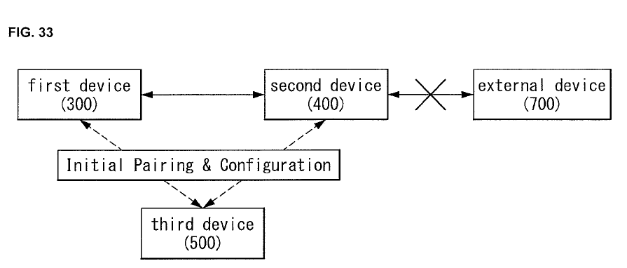

FIG. 33 is a schematic view illustrating an example of a method for preventing control by an external device according to an embodiment of the present disclosure.

Referring to FIG. 33, the control device may control pairing and connection of the first device 300 and the second device 400 through the embodiments described above.

However, in cases where the first device 300 and the second device 400 do not have a user interface (UI), an external connection request has no choice but to be allowed. In this case, a problem arises in that an unintended external device 600 may control the first device 300 and the second device 400.

For example, multiple devices may control the first device 300 and the second device 400 or a malicious external device 600 may control the first device 300 and the second device 400.

Thus, in order to solve the problem, the present disclosure proposes a method in which the first device 300 and the second device 400 perform pairing/connection through a control device.

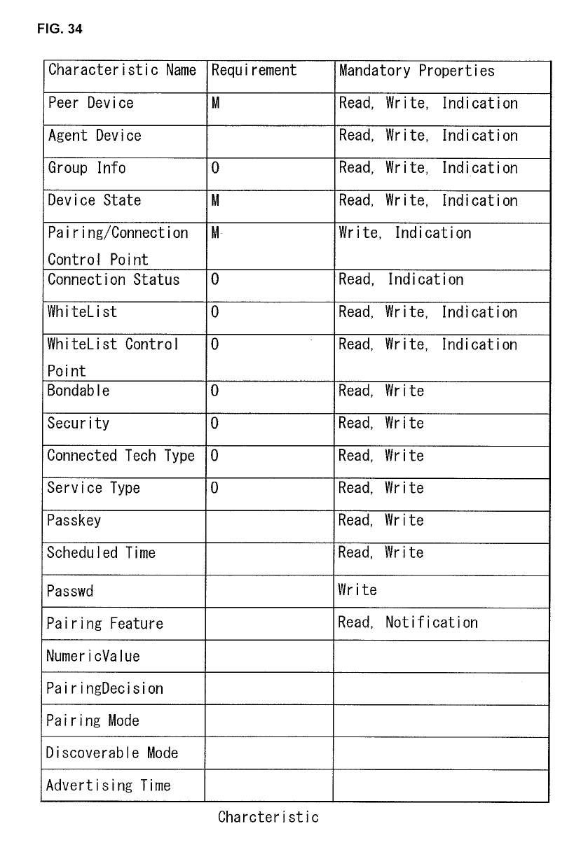

FIG. 34 is a view illustrating an example of characteristics of a GATT for preventing control by an external device according to an embodiment of the present disclosure.

Referring to FIG. 34, there may be characteristics for the first device and the second device to be paired/connected through a control device, other than the characteristics described above with reference to FIG. 25.

Numeric Value: It is a numeric value when a numeric comparison method is used

PairingDecision: It is a function indicating whether a control device permits pairing to a counterpart device during a pairing process

Pairing Mode: It is a function for setting a pairing mode used in a pairing procedure by a control device

Discoverable Mode: It is a function for indicating a supportable discoverable mode or setting a discoverable mode by a control device

Advertising Time: It is a function for setting a time for performing an advertising operation by a control device

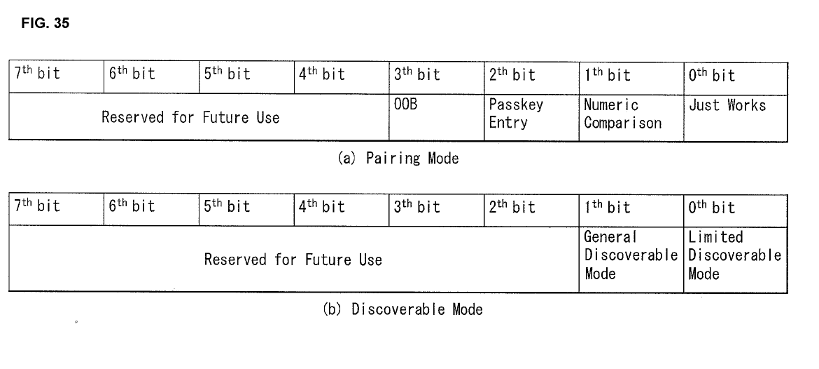

FIG. 35 is a view illustrating an example of each characteristic according to an embodiment of the present disclosure.

(a) of FIG. 35 illustrates an example of a pairing mode among characteristics discussed above with reference to FIG. 34, and (b) of FIG. 35 illustrates an example of discover mode characteristic.

Through the pairing mode characteristic illustrated in (a) of FIG. 35, the control device may obtain information regarding a pairing mode supported by a controlled device or set the controlled device to operate in a specific pairing mode.

For example, the control device may transmit a read request message of pairing mode characteristic to the controlled device and receive a read response message including pairing mode information transmitted from the controlled device, thereby obtaining information regarding a pairing mode supported by the controlled device.

Here, the pairing mode information may set a bit of the supported pairing mode to ‘1’ and a bit of an unsupported pairing mode to ‘0’.

Also, the control device may set the controlled device to operate in a specific pairing mode through the pairing mode characteristic of the controlled device.

For example, in order to set a specific bit of the pairing mode characteristic of the controlled device to ‘1’, the control device may transmit a write request message to the controlled device, and the controlled device may receive the write request message and set a specific bit of the pairing mode characteristic to ‘1’.

Thereafter, the controlled device performs pairing in the pairing mode corresponding to the specific bit.

Through the discoverable mode characteristic illustrated in (b) of FIG. 35, the control device may obtain information regarding a discoverable mode supported by the controlled device or set the controlled device to operate in the specific discoverable mode.

For example, the control device may transmit a read request message of the discoverable mode characteristic to the controlled device and receive a read response message including discoverable mode information transmitted from the controlled device, thereby obtaining information regarding the discoverable mode supported by the controlled device.

Here, the discoverable mode information may set a bit of the supported discoverable mode to ‘1’ and a bit of an unsupported discoverable mode to ‘1’.

Also, the control device may set the controlled device to operate in a specific discoverable mode through the discoverable mode characteristic of the controlled device.

For example, in order to set a specific bit of the discoverable mode characteristic of the controlled device to ‘1’, the control device may transmit a write request message to the controlled device, and the controlled device may receive the write request message and set a specific bit of the discoverable mode characteristic to ‘1’.

Thereafter, the controlled device operates in the discoverable mode corresponding to the specific bit.

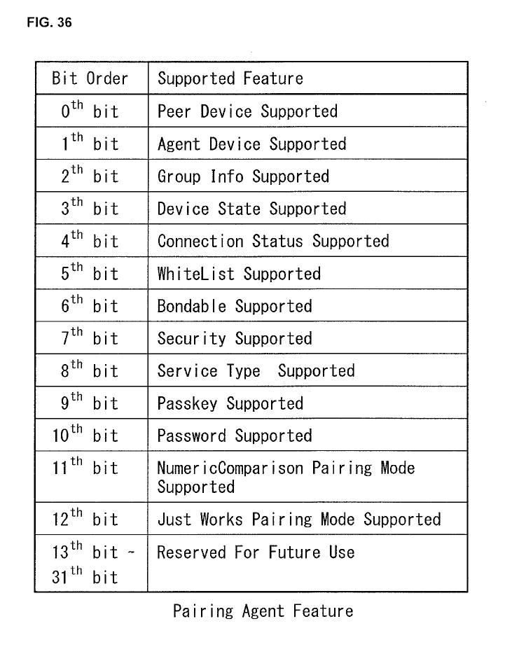

FIG. 36 is a view illustrating an example of characteristic information representing characteristics provided by a device according to an embodiment of the present disclosure.

The characteristic information illustrated in FIG. 36 is another embodiment of the characteristic information described above with reference to FIG. 26, and a device may include the characteristic information in an advertising message and transmit the same to a device nearby to inform the peripheral control device about characteristics of a GATT which can be provided by the device.

Also, the characteristic information illustrated in FIG. 36 may be an example of Pairing Feature of FIG. 34.

The characteristic information may be expressed in the form of a bit, and through the characteristic information, the control device may know which function of the device can be controlled.

NumericComparison Pairing Mode Supported: It indicates that pairing using numeric comparison is possible and a characteristic regarding a numeric value is supported

JustWorks Pairing Mode Supported: It indicates that pairing using JustWorks is possible.

In addition, although not shown in FIG. 36, information indicating whether an out-of-band (OOB) method is supported may also be included in the characteristic information.

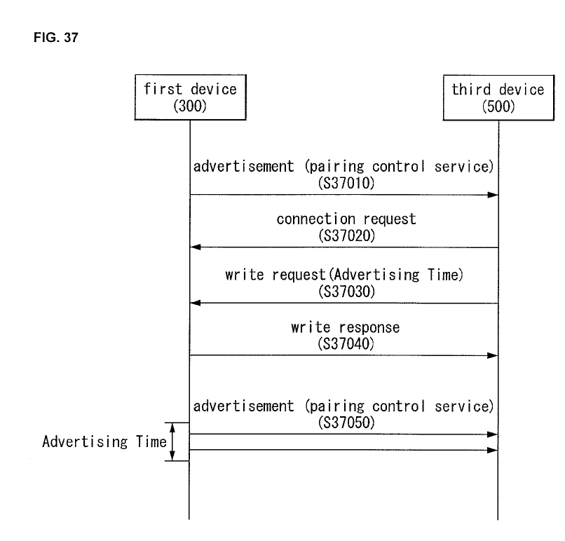

FIG. 37 is a flow chart illustrating an example of a method for controlling an advertising operation of a device according to an embodiment of the present disclosure.

Referring to FIG. 37, the third device 500, a control device, may set an operation time of an advertising operation of the first device 300 as a controlled device, thus controlling the first device 300 to perform an advertising operation only for a specific time.

In detail, the first device 300 transmits an advertising message (first advertising message) to the third device 500 (S37010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, role information of the first device, and/or the characteristic information discussed above with reference to FIG. 36.

For example, the advertising message may include information indicating that the first device 300 provides a pairing control service.

Here, the pairing control service refers to a service supported in BLE to control a connection of other devices through the control device in Bluetooth communication.

Also, the advertising message may be transmitted to the third device 500 in a broadcast manner or unicast manner.

Upon receiving the advertising message, the third device 500 may know that the first device 300 provides the pairing control service.

The third device 500 transmits a connection request message to form a BLE connection with the first device 300 on the basis of the advertising message transmitted from the first device 300 (S37020).

Thereafter, the third device 500 and the first device 300 may perform a connection procedure described above with reference to FIG. 6 so as to be connected through BLE.

When the third device 500 is connected to the first device 300 through BLE, the third device 500 may transmit a write request message requesting writing of a specific time to “Advertising Time” characteristic of the first device 300 to set the first device 300 to transmit an advertising message only for the specific time (S37030).

Upon receiving the write request message, the first device 300 transmits a write response message as a response thereto, and sets the “Advertising Time” as a specific time (S37040).

Thereafter, the first device 300 may perform an advertising operation of transmitting an advertising message (second advertising message) to a device nearby only for the specific time (S37050).

The advertising message may include service information supported by the first device 300, information related to the first device, role information of the first device, and/or the characteristic information discussed above with reference to FIG. 36.

For example, the advertising message may include information indicating that the first device 300 provides a pairing control service.

Here, the pairing control service refers to a service supported in BLE to control a connection of another device through a control device in Bluetooth communication.

Also, the advertising message may be transmitted to the third device 500 in a broadcast manner or unicast manner.

For example, the first device 300 may transmit the advertising message only for the specific time when power is turned on or when a request for performing an advertising operation is received.

In this manner, the third device 500 may control the first device 300 to transmit the advertising message only for the specific time to perform pairing/connection.

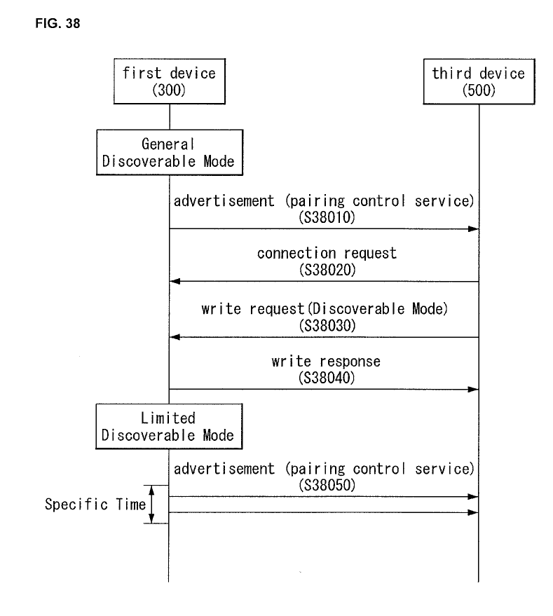

FIG. 38 is a flow chart illustrating another example of a method for controlling an advertising operation of a device according to an embodiment of the present disclosure.

Referring to FIG. 38, the third device 500, a control device, may set a discoverable mode of the first device 300, thus controlling the first device 300 to operate in the specific discoverable mode.

In detail, the first device 300 transmits an advertising message (first advertising message) to the third device 500 (S38010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, role information of the first device, and/or the characteristic information discussed above with reference to FIG. 36.

For example, the advertising message may include information indicating that the first device 300 provides a pairing control service.

Here, the pairing control service refers to a service supported in BLE to control a connection of other devices through the control device in Bluetooth communication.

Also, the advertising message may be transmitted to the third device 500 in a broadcast manner or unicast manner.

Upon receiving the advertising message, the third device 500 may know that the first device 300 provides the pairing control service.

The third device 500 transmits a connection request message to form a BLE connection with the first device 300 on the basis of the advertising message transmitted from the first device 300 (S38020).

Thereafter, the third device 500 and the first device 300 may perform a connection procedure described above with reference to FIG. 6 so as to be connected through BLE.

When the third device 500 is connected to the first device 300 through BLE, the third device 500 may transmit a write request message requesting setting a bit of a limited discoverable mode of the “Discoverable Mode” characteristic of the first device 300 to ‘1’ to set the first device 300 to operate in the limited discoverable mode (S38030).

Upon receiving the write request message, the first device 300 transmits a write response message as a response thereto, and sets a bit of the “Limited Discoverable Mode” to ‘1’ (S38040).

Thereafter, the first device 300 operates in the Limited Discoverable Mode.

For example, the first device 300 may transmit the advertising message (second advertising message) to a device nearby only for a specific time (S38050).

The advertising message may include service information supported by the first device 300, information related to the first device, role information of the first device, and/or the characteristic information discussed above with reference to FIG. 36.

For example, the advertising message may include information indicating that the first device 300 provides a pairing control service.

Here, the pairing control service refers to a service supported in BLE to control a connection of another device through a control device in Bluetooth communication.

Also, the advertising message may be transmitted to the third device 500 in a broadcast manner or unicast manner.

In this manner, the third device 500 may set the first device 300 to operate in the specific discoverable mode and control the first device 300 to transmit an advertising message only for the specific time to perform pairing/connection.

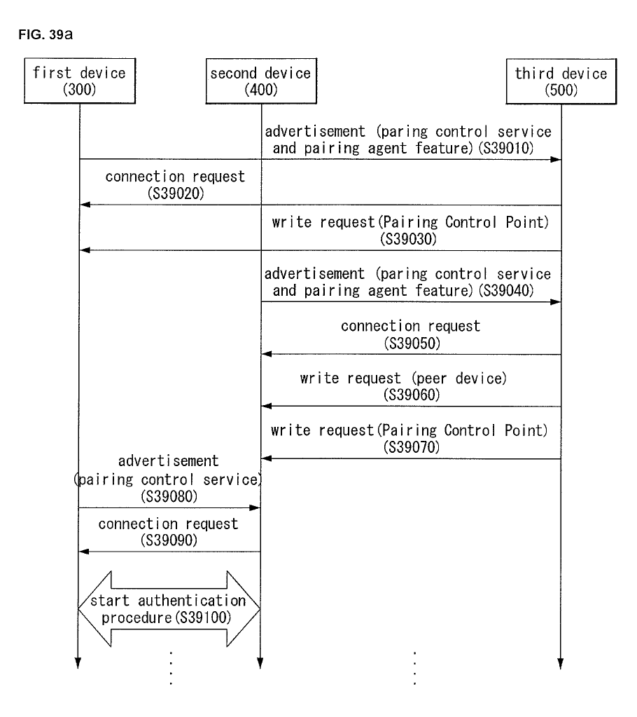

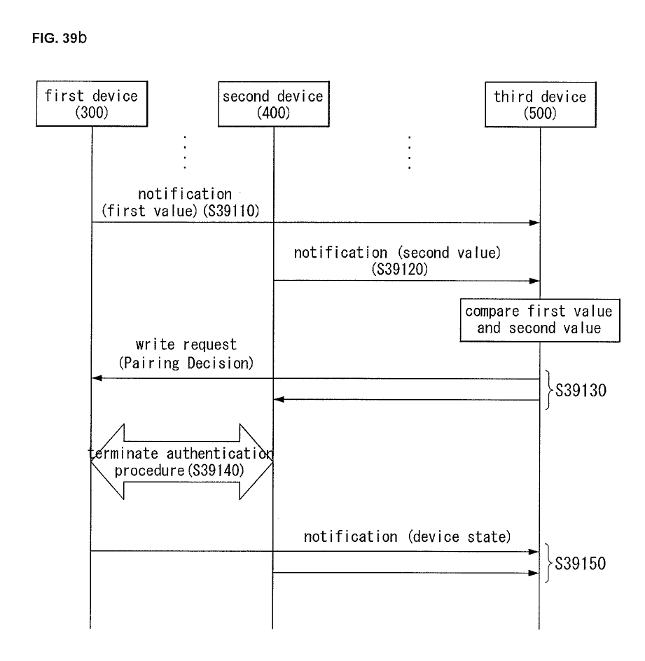

FIGS. 39A and 39B are views illustrating an example of a method for performing a procedure for pairing devices by a control device according to an embodiment of the present disclosure.

Referring to FIGS. 39A and 39B, the third device 500, a control device, may control pairing upon receiving passkeys from the first device 300 and the second device 400, controlled devices.

In detail, the third device 500 receives an advertising message (first advertising message) from the first device 300 (S39010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, role information of the first device, and/or the characteristic information discussed above with reference to FIG. 36.

The characteristic information may include pairing mode information (first pairing mode information) supported by the first device.

For example, the advertising message may include information indicating that the first device 300 provides a pairing control service, and, in the characteristic information, a bit corresponding to a pairing mode supported by the first device 300 may be set to ‘1’.

Hereinafter, it is assumed that a bit corresponding to a numeric comparison pairing mode of the characteristic information is set to ‘1’.

Here, the pairing control service refers to a service supported in BLE to control a connection of another device through the control device in Bluetooth communication.

Also, the advertising message may be transmitted to the third device 500 in a broadcast manner or unicast manner.

Upon receiving the advertising message, the third device 500 may know that the first device 300 provides the pairing control service and supports the numeric comparison pairing mode.

The third device 500 transmits a connection request message to form a BLE connection with the first device 300 on the basis of the advertising message transmitted from the first device 300 (S39020).

Thereafter, the third device 500 and the first device 300 may perform a connection procedure described above with reference to FIG. 6 so as to be connected through BLE.

The third device 500 may instruct the first device 300 to perform an advertising operation.

That is, the third device 500 may transmit a write request message requesting writing of a portion corresponding to Advertising Start of the pairing/connection control point characteristic to the first device 300 (S39030).

The write request message may be expressed as a control message, or the like.

Here, the write request message may include an operation code (first operation code) indicating the advertising operation, and the first device 300 may perform the advertising operation, while maintaining a connection stated with the third device 500.

Also, the control device may perform an operation to control the second device 400.

The third device 500 receives an advertising message (second advertising message) from the second device 400 (S39040). The advertising message may be expressed as an advertisement pack data unit (PDU), an advertisement packet, an advertisement, an advertisement frame, an advertisement physical channel PDU, and the like.

The advertising message may include service information supported by the second device 400, information related to the second device, role information of the second device, and/or the characteristic information discussed above with reference to FIG. 36.

The characteristic information may include pairing mode information (first pairing mode information) supported by the second device.

For example, the advertising message may include information indicating that the second device 400 provides a pairing control service, and, in the characteristic information, a bit corresponding to a pairing mode supported by the first device 300 may be set to ‘1’.

Hereinafter, it is assumed that a bit corresponding to the numeric comparison pairing mode of the characteristic information is set to ‘1’.

Here, the pairing control service refers to a service supported in BLE to control a connection of another device through the control device in Bluetooth communication.

Also, the advertising message may be transmitted to the third device 500 in a broadcast manner or unicast manner.

Upon receiving the advertising message, the third device 500 may know that the second device 400 provides the pairing control service and supports the numeric comparison pairing mode.

The third device 500 transmits a connection request message to form a BLE connection with the second device 400 on the basis of the advertising message transmitted from the second device 400 (S39050).

Thereafter, the third device 500 and the second device 400 may perform a connection procedure described above with reference to FIG. 6 so as to be connected through BLE.

The third device 500 may instruct the first device 300 to perform an advertising operation.

That is, the third device 500 may transmit a write request message requesting writing of an address of the first device 300 to the Peer Device characteristic, to the second device 400 (S39060).

When the second device 400 receives an advertising message from the first device, the third device 500 may control the second device 400 to transmit a connection request message to the first device 300.

That is, the third device may transmit a write request message requesting writing of a corresponding portion in a connection request of the pairing/connection control point characteristic of the second device 400 (S39070).

The write request message may be expressed as a control message, or the like.

Here, the write request message may include an operation code (second operation code) for indicating a connection operation of transmitting the connection request message and an ID (e.g., a friendly name or device address) of the first device for transmitting the connection request message to the first device 300.

Although not shown in FIG. 39A, the control device 500 may transmit a write request message to the first device 300 and the second device 400 to set the first device 300 and the second device 400 to operate in a specific paring mode.

Here, the specific pairing mode is one of pairing modes supported by both the first device 300 and the second device 400.

Thereafter, the first device 300 transmits an advertising message to the second device 400 (S39080), and the second device 400 transmits a connection request message to the first device (S39090).

Upon receiving the connection request message, the first device 300 may perform an authentication procedure with the second device 400.

Here, since both the first device 300 and the second device 400 support the numeric comparison scheme, the first device 300 and the second device 400 may perform the authentication procedure through the numeric comparison.

For the authentication procedure, the first device 300 transmits a first value (e.g., a numeric value or a passkey value) to the control device 500, and transmits a notification message including a second value (e.g., a numeric value or a passkey value) to the second device 400 (S39110, S39120).

The control device compares the first value and the second value, and when the values are the same, the control device determines that the authentication process was normally terminated and transmits a write request message requesting writing of a value indicating successful device authentication to the ParingDecision characteristic to the first device 300 and the second device 400 (S39130).

If, however, the first value and the second value are different, the control device request the first device 300 and the second device 400 to write a value indicating device failure to the PairingDecision characteristic to terminate the authentication process.

Thereafter, the authentication procedure is terminated (539140), and the first device 300 and the second device 400 may include state information indicating a result of the authentication procedure in a notification message and transmit the same to the third device 500 (S39150).

In this manner, the first device 300 and the second device 400 may perform pairing through the third device 500, a control device, thus preventing performing pairing with an external device nearby.

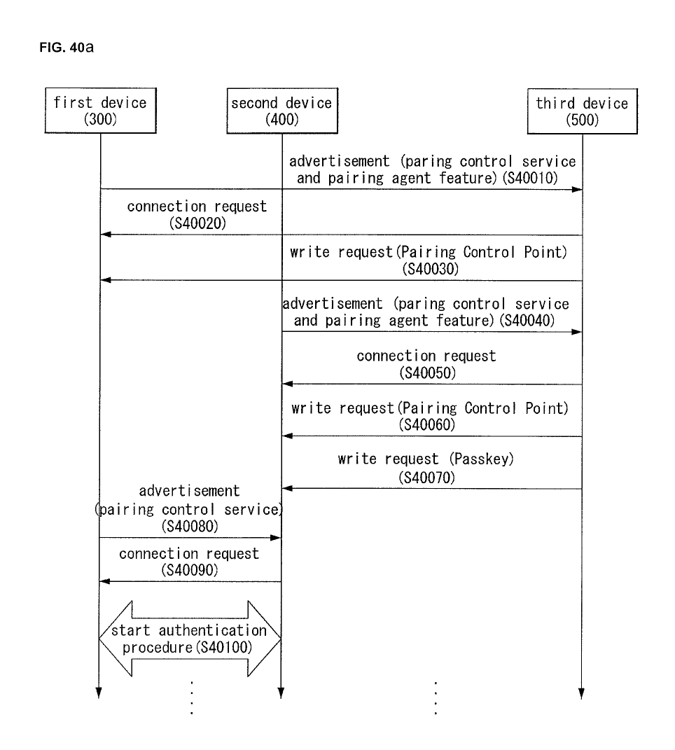

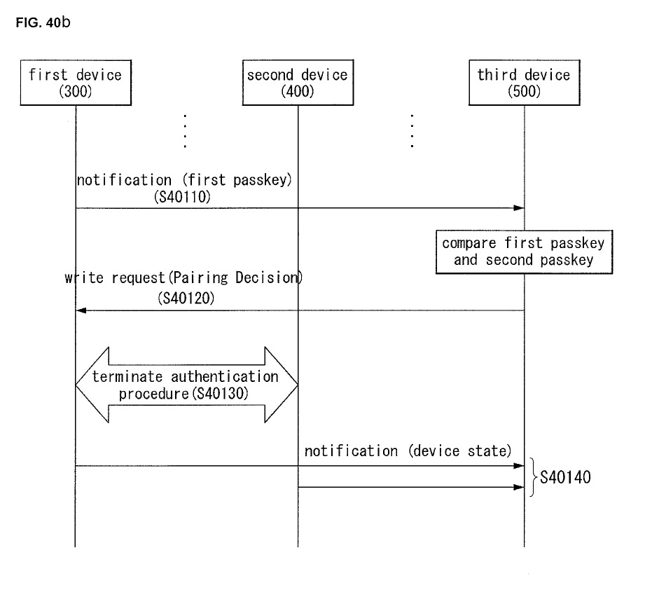

FIGS. 40A and 40B are views illustrating another example of a method for performing a procedure for pairing devices by a control device according to an embodiment of the present disclosure.

Referring to FIGS. 40A and 40B, the third device 500, a control device, may control pairing of the first device 300 and the second device 400, controlled devices, through a PassKey Entry method.

In detail, the third device 500 receives an advertising message (first advertising message) from the first device 300 (S40010). The advertising message may be expressed as an advertisement pack data unit (PDU), an advertisement packet, an advertisement, an advertisement frame, an advertisement physical channel PDU, and the like.

The advertising message may include service information supported by the first device 300, information related to the first device, role information of the first device, and/or the characteristic information discussed above with reference to FIG. 36.

The characteristic information may include pairing mode information (first pairing mode information) supported by the first device.

For example, the advertising message may include information indicating that the first device 300 provides a pairing control service, and, in the characteristic information, a bit corresponding to a pairing mode supported by the first device 300 may be set to ‘1’.

Hereinafter, it is assumed that a bit corresponding to PassKey Entry of the characteristic information is set to ‘1’.

Here, the pairing control service refers to a service supported in BLE to control a connection of another device through the control device in Bluetooth communication.

Also, the advertising message may be transmitted to the third device 500 in a broadcast manner or unicast manner.

Upon receiving the advertising message, the third device 500 may know that the first device 300 provides the pairing control service and supports the Passkey Entry pairing mode.

The third device 500 transmits a connection request message to form a BLE connection with the first device 300 on the basis of the advertising message transmitted from the first device 300 (S40020).

Thereafter, the third device 500 and the first device 300 may perform a connection procedure described above with reference to FIG. 6 so as to be connected through BLE.

The third device 500 may instruct the first device 300 to perform an advertising operation.

That is, the third device 500 may transmit a write request message requesting writing of a portion corresponding to Advertising Start of the pairing/connection control point characteristic to the first device 300 (S40030).

The write request message may be expressed as a control message, or the like.

Here, the write request message may include an operation code (first operation code) indicating the advertising operation, and the first device 300 may perform the advertising operation, while maintaining a connection stated with the third device 500.

Also, the control device may perform an operation to control the second device 400.

The third device 500 receives an advertising message (second advertising message) from the second device 400 (S40040). The advertising message may be expressed as an advertisement pack data unit (PDU), an advertisement packet, an advertisement, an advertisement frame, an advertisement physical channel PDU, and the like.

The advertising message may include service information supported by the second device 400, information related to the second device, role information of the second device, and/or the characteristic information discussed above with reference to FIG. 36.

The characteristic information may include pairing mode information (first pairing mode information) supported by the second device.

For example, the advertising message may include information indicating that the second device 400 provides a pairing control service, and, in the characteristic information, a bit corresponding to a pairing mode supported by the first device 300 may be set to ‘1’.

Hereinafter, it is assumed that a bit corresponding to the PassKey Entry Pairing Mode of the characteristic information is set to ‘1’.

Here, the pairing control service refers to a service supported in BLE to control a connection of another device through the control device in Bluetooth communication.

Also, the advertising message may be transmitted to the third device 500 in a broadcast manner or unicast manner.

Upon receiving the advertising message, the third device 500 may know that the second device 400 provides the pairing control service and supports the PassKey Entry Pairing Mode.

The third device 500 transmits a connection request message to form a BLE connection with the second device 400 on the basis of the advertising message transmitted from the second device 400 (S40050).

Thereafter, the third device 500 and the second device 400 may perform a connection procedure described above with reference to FIG. 6 so as to be connected through BLE.

When the second device 400 receives an advertising message from the first device, the third device 500 may control the second device 400 to transmit a connection request message to the first device 300.

That is, the third device may transmit a write request message requesting writing of a corresponding portion in a connection request of the pairing/connection control point characteristic of the second device 400 (S40060).

The write request message may be expressed as a control message, or the like.

Here, in order to transmit the connection request message to the first device 300, the write request message may include an ID (e.g., friendly name or device address) of the first device.

Although not shown in FIGS. 40A and 40B, the control device 500 may transmit a write request message to the first device 300 and the second device 400 to set the first device 300 and the second device 400 to operate in a specific paring mode.

Here, the specific pairing mode is one of pairing modes supported by both the first device 300 and the second device 400.

When the third device 500 wants to control pairing of the first device 300 and the second device 400 through the PassKey Entry scheme, the third device 500 may transmit a write request message requesting writing of PassKey to the second device 400 (S40070).

As described above, the PassKey refers to a value for performing pairing through the PassKey Entry scheme, and the third device 500 may request writing of a Passkey value (first Passkey) to the Passkey characteristic of the second device 400 through the write request message.

Thereafter, the first device 300 transmits an advertising message to the second device 400 (S40080), and the second device 400 transmits a connection request message to the first device (S40090).

Upon receiving the connection request message, the first device 300 may perform an authentication procedure with the second device 400.

Here, since both the first device 300 and the second device 400 support the Passkey Entry method, the first device 300 and the second device 400 may perform the authentication procedure through the Passkey Entry method.

For the authentication procedure, the first device 300 transmits a notification message including a second Passkey to the third device 500 (S40110).

The third device compares the first passkey transmitted to the second device and the second passkey, and when the values (first passkey and the second passkey) are the same, the third device determines that the authentication process was normally terminated and transmits a write request message requesting writing of a value indicating successful device authentication to the ParingDecision characteristic to the first device 300 and the second device 400 (S40120).

If, however, the first value and the second value are different, the control device request the first device 300 and the second device 400 to write a value indicating device failure to the PairingDecision characteristic to terminate the authentication process.

Thereafter, the authentication procedure is terminated (S40130), and the first device 300 and the second device 400 may include state information indicating a result of the authentication procedure in a notification message and transmit the same to the third device 500 (S40140).

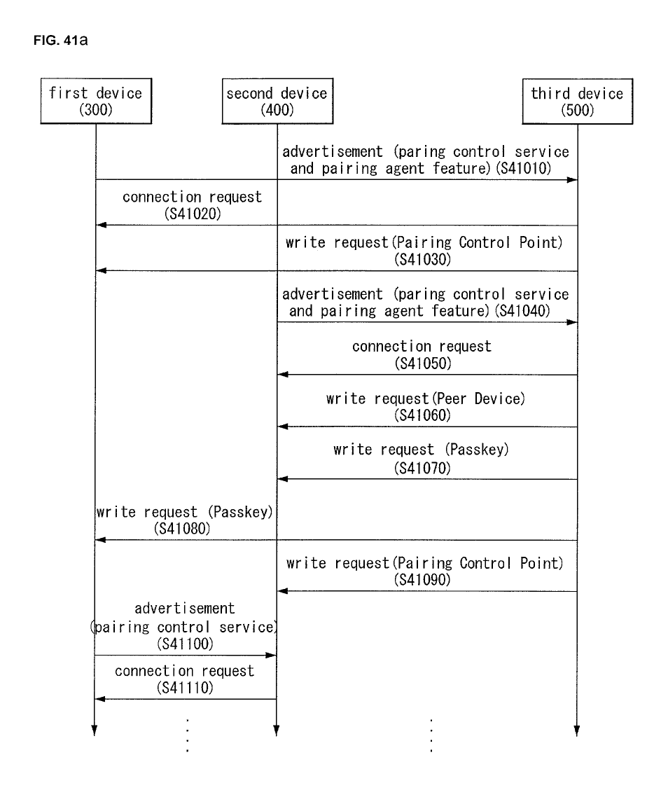

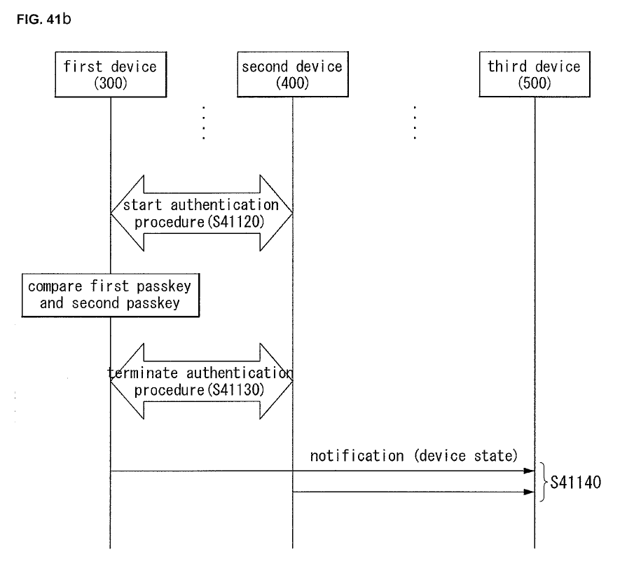

FIGS. 41A and 41B are views illustrating another example of a method for performing a procedure for pairing devices by a control device according to an embodiment of the present disclosure.

Referring to FIGS. 41A and 41B, the third device 500, a control device, may set PassKey of the first device 300 and the second device 400 and control pairing of the first device 300 and the second device 400 through a Passkey Entry scheme.

First, step S41010 to step S41050 are the same as step S40010 to step S40050 of FIG. 40A, so descriptions thereof will be omitted.

Thereafter, the third device 500 and the first device 300 may perform a connection procedure so as to be connected through BLE as described above with reference to FIG. 6.

The third device 500 may set the first device 300 as a device to which the second device 400 is to be connected.

That is, the third device 500 may transmit a write request message requesting writing of an address of the first device 300 to the Peer Device characteristics, to the second device 40Q (S41060).

Although not shown in FIGS. 41A and 41B, the control device 500 may transmit a write request message to the first device 300 and the second device 400 to set the first device 300 and the second device 400 to operate in a specific paring mode.

Here, the specific pairing mode is one of pairing modes supported by both the first device 300 and the second device 400.

The third device 500 may transmit Passkey to the first device 300 and the second device 400 such that the first device 300 and the second device 400 perform pairing through the Passkey Entry scheme.

That is, the third device 500 may transmit a write request message requesting writing of a passkey (second passkey) to the second device 400 (S41070), and the second device 400 may store the second passkey to the passkey characteristic described above with reference to FIG. 34.

Also, the third device 500 may transmit a write request message requesting writing of a passkey (first passkey) to the first device 300 (S41080), and the first device 300 may store the first passkey in the passkey characteristic described above with reference to FIG. 34.

When the second device 400 receives an advertising message from the first device, the third device 500 may control the second device 400 to transmit a connection request message to the first device 300.

That is, the third device may transmit a write request message requesting writing of a corresponding portion in a connection request of the pairing/connection control point characteristic of the second device 400 (S41090).

The write request message may be expressed as a control message, or the like.

Thereafter, the first device 300 transmits an advertising message to the second device 400 (S41100), and the second device 400 transmits a connection request message to the first device (S41110).

Upon receiving the connection request message, the first device 300 may perform an authentication procedure with the second device 400.

Here, since both the first device 300 and the second device 400 support the Passkey Entry method, the first device 300 and the second device 400 may perform the authentication procedure through the Passkey Entry method.

The first device 300 receives the second passkey through a user or any other means and compares the first passkey and the second passkey. When the both passkeys have the same value, the first device 300 determines that the authentication process was normally terminated.

If, however, the first value and the second value are different, the authentication process is stopped and the first device 300 and the second device 400 cannot be paired.

Thereafter, the authentication procedure is terminated (S41130), and the first device 300 and the second device 400 may include state information indicating a result of the authentication procedure in a notification message and transmit the same to the third device 500 (S41140).

In this manner, the control device may control pairing between devices by setting the passkeys of the devices, and prevent the devices from performing pairing with any other external devices.

The aforementioned embodiments may be separately performed or may be combined to be performed.

The embodiments described above may be variously modified and changed by those skilled in the art to which the present invention pertains without departing from the scope of the technical concept of the present invention, and thus are not limited to the aforementioned embodiments and accompanying drawings.

### INDUSTRIAL APPLICABILITY

This specification relates to Bluetooth data transmission and reception and, more particularly, to a method and device for controlling pairing and connecting between devices using a Bluetooth low energy (LE) technology.

1. A method for controlling, by a control device, a first device and a second device using a Bluetooth low energy (BLE) technology, the method comprising:
receiving a first advertising message including at least one of first service information or first pairing mode information supported by the first device from the first device;
establishing a BLE connection with the first device;
transmitting a first control message including a first operation code indicating an advertising operation to the first device;
receiving a second advertising message including at least one of second service information or second pairing mode information supported by the second device from the second device;
establishing a BLE connection with the second device;
transmitting a second control message including a second operation code indicating a connection operation and an ID indicating the first device to the second device; and
receiving a notification message including state information indicating a pairing result from at least one of the first device or the second device.

2. The method of claim 1,
wherein each of the first pairing mode information and the second pairing mode information includes at least one of OOB (Out-Of-Band), Passkey Entry, Numeric Comparison, or Just works.

3. The method of claim 1, further comprising:
transmitting a first write request message for setting a pairing mode of the first device to a first specific pairing mode, to the first device; and
transmitting a second write request message for setting a pairing mode of the second device to a second specific pairing mode, to the second device,
wherein the first specific pairing mode and the second specific pairing mode is one of OOB (Out-Of-Band), Passkey Entry, Numeric Comparison, and Just works.

4. The method of claim 1, further comprising:
receiving a first value for device authentication from the first device;
receiving a second value for device authentication from the second device; and
comparing the first value and the second value.

5. The method of claim 4, further comprising:
transmitting a write request message requesting writing of whether pairing is permitted to at least one of the first device and the second device according to a comparison result.

6. The method of claim 5,
wherein the write request message requests writing of permission of pairing, when the first value is the same as the second value.

7. The method of claim 5,
wherein the write request message requests writing of non-permission of pairing, when the first value and the second value are different.

8. The method of claim 1, further comprising:
transmitting a first write request message requesting writing of a first passkey value for device authentication to the second device;
receiving a second passkey value for device authentication from the first device; and
comparing the first passkey value and the second passkey value.

9. The method of claim 8, further comprising:
transmitting a second write request message requesting writing of whether pairing is permitted, to the first device according to a comparison result.

10. The method of claim 1, further comprising:
transmitting a first write request message requesting writing of a first passkey value for device authentication to the first device; and
transmitting a second write request message requesting writing of a second passkey value for device authentication to the second device.

11. A method for causing the first device to be paired with a second device by a control device using Bluetooth low energy (BLE), the method comprising:
transmitting a first advertising message including at least one of first service information or first pairing mode information supported by the first device, to the control device;
establishing a Bluetooth low energy (BLE) connection with the control device;
receiving a first control message including a first operation code indicating an advertising operation from the control device;
transmitting a second advertising message to the second device according to the first operation code;
receiving a connection request message requesting formation of a BLE connection from the second device;
performing a device authentication procedure with the second device; and
transmitting a notification message including state information indicating a pairing result to the control device.

12. The method of claim 11, further comprising:
receiving a first write request message for setting a pairing mode of the first device to a specific pairing mode, from the first device; and
performing the authentication procedure with the second device through the specific pairing mode,
wherein the specific pairing mode and the second specific pairing mode is one of OOB (Out-Of-Band), Passkey Entry, Numeric Comparison, and Just works.

13. The method of claim 11, further comprising:
receiving a write request message requesting writing of an operation time of an advertising operation for transmitting the second advertising message, from the control device; and
transmitting a write response message as a response with respect to the write request message,
wherein the second advertising message is transmitted only for the operation time.

14. The method of claim 11, further comprising:
receiving a first write request message requesting writing of a first passkey value for device authentication from the control device; and
setting a passkey for the authentication procedure to the first passkey value.

15. The method of claim 14, wherein the performing of the authentication procedure further comprises:
receiving a second passkey value for authentication of the second device; and
comparing the first passkey value and the second passkey value.

16. The method of claim 15,
wherein the state information indicates successful pairing, when the first passkey value and the second passkey value are the same.

17. The method of claim 15,
wherein, the state information indicates pairing failure, when the first passkey value and the second passkey value are different.

18. The method of claim 11, further comprising:
receiving a write request message for setting a discoverable mode for transmitting the second advertising message to a specific discoverable mode, from the control device; and
transmitting a write response message as a response with respect to the write request message,
wherein the specific discoverable mode is one of a general discoverable mode and a limited discoverable mode, and the advertising message is transmitted in the specific discoverable mode.

19. A device as a first device for controlling a second device using Bluetooth low energy (BLE), the device comprising:
a communication unit communicating with the exterior wirelessly or wiredly; and
a processor functionally connected to the communication unit,
wherein the processor performs control to
receive a first advertising message including at least one of first service information or first pairing mode information supported by the first device from the first device,
establish a BLE connection with the first device,
transmit a first control message including a first operation code indicating an advertising operation to the first device,
receive a second advertising message including at least one of second service information or second pairing mode information supported by the second device from the second device,
establish a BLE connection with the second device,
transmit a second control message including a second operation code indicating a connection operation and an ID indicating the first device to the second device; and
receive a notification message including state information indicating a pairing result from at least one of the first device or the second device.
